(19) United States
(12) Patent Application Publication
(10) Pub. No.: US 2014/0334684 A1
(43) Pub. Date: Nov. 13, 2014

(54) SYSTEM AND METHOD FOR NEIGHBORHOOD-SCALE VEHICLE MONITORING

(71) Applicant: Jonathan Strimling, Bedford, NH (US)

(72) Inventor: Jonathan Strimling, Bedford, NH (US)

(21) Appl. No.: 14/361,304

(22) PCT Filed: Aug. 20, 2013
(86) PCT No.: PCT/US13/55650

§ 371 Date: May 29, 2014

Related U.S. Application Data
(60) Provisional application No. 61/810,240, filed on Apr. 9, 2013.
(60) Provisional application No. 61/817,834, filed on Apr. 30, 2013.
(60) Provisional application No. 61/803,450, filed on Mar. 19, 2013.
(60) Provisional application No. 61/764,520, filed on Feb. 13, 2013.
(60) Provisional application No. 61/834,188, filed on Jun. 12, 2013.
(60) Provisional application No. 61/806,386, filed on Mar. 28, 2013.
(60) Provisional application No. 61/789,034, filed on Mar. 15, 2013.
(60) Provisional application No. 61/827,575, filed on May 25, 2013.
(60) Provisional application No. 61/691,149, filed on Aug. 20, 2012.
(60) Provisional application No. 61/764,507, filed on Feb. 13, 2013.

(51) Int. Cl. G06K 9/00; G08G 1/123; G07C 9/00; G06K 9/32

(52) U.S. Cl. CPC G06K 9/00771; G06K 9/3258; G08G 1/123; G07C 9/00111
USPC 382/105; 382/104

(57) ABSTRACT

A system and method may include a station to identify a vehicle and to determine a characterizing feature of the vehicle. An imager that is located remotely from the station is configured to acquire an image of the vehicle that includes the characterizing feature. A processor is configured to detect the characterizing feature in the acquired image and to associate the detected characterizing feature with the identified vehicle so as to predict a location of the vehicle.

### FIELD OF THE INVENTION

The present invention relates to security systems. More particularly, the present invention relates to a cost-effective vehicle monitoring system for areas encompassing multiple properties with multiple access points, such as a neighborhood.

### BACKGROUND OF THE INVENTION

Home and automobile theft remain issues of persistent social concern and negative economic impact, while creating an ongoing stream of criminal activities. Though security systems are currently available for the home and automobile, they tend to be relatively costly, and have therefore had only moderate acceptance by the general public.

Conventional systems that are available for residential security rely on cameras for monitoring or recording video footage at the property, and typically include an array of sensors for sensing entry into the property. While conventional systems are capable of detecting intrusion into a residence, or motion on a property, it is typically cost-prohibitive to provide positive identification of vehicles entering a property, due to the costs of equipment capable of positively identifying vehicles.

### SUMMARY OF THE INVENTION

There is provided, in accordance with some embodiments of the present invention, a system and method for identifying a vehicle entering a property (such a residence), using a shared sensor at a location remote from the property capable of positively identifying a vehicle, and less costly sensors at the property. In some embodiments, a set of one or more shared remote sensors may be located in a manner to control access to a number of properties (such as at the entrances to a neighborhood), so that vehicles entering the neighborhood may be positively identified, and then entrances of vehicles to specific properties may then be correlated to the entry of vehicles into the neighborhood, as is described herein.

In accordance with some embodiments of this invention, this may include a system including: a station to identify a vehicle and to determine a characterizing feature of the vehicle; an imager located remotely from the station, the imager to acquire an image of the vehicle that includes the characterizing feature; and a processor to detect the characterizing feature in the acquired image and to associate the detected characterizing feature with the identified vehicle so as to predict a location of the vehicle.

Furthermore, in accordance with some embodiments of the present invention, the station is configured to indicate a time at which the vehicle is identified and the imager is configured to indicate a time at which the image was captured.

Furthermore, in accordance with some embodiments of the present invention, the processor is configured to calculate a velocity of the vehicle at a point between the station and the imager, and to predict a time of arrival of the vehicle at the imager.

Furthermore, in accordance with some embodiments of the present invention, the station includes a license plate reader to identify the vehicle by reading a license plate of the vehicle.

Furthermore, in accordance with some embodiments of the present invention, the station includes an RFID reading device for to identify the vehicle by reading an RFID tag of the vehicle.

There is further provided, in accordance with some embodiments of the present invention,

a system for predicting an identity of a vehicle detected by multiple sensors, the system including: a first sensor in a first location to detect a unique identifier of the vehicle; a second sensor in a second location, said second sensor suitable to capture a second identifier of the vehicle, the second sensor not suitable to detect the unique identifier; a processor, said processor to associate the unique identifier with the second identifier, and to predict that the vehicle detected by the second sensor in the second location is the vehicle detected by the first sensor in the first location.

Furthermore, in accordance with some embodiments of the present invention, the first sensor includes a license plate reader, and wherein the unique identifier comprises a license plate identifier, and wherein the first sensor is to detect at the first location the license plate identifier.

Furthermore, in accordance with some embodiments of the present invention, the second sensor includes an imager, the imager in the second location suitable to capture from the second location an image of the vehicle, the image including the second identifier of the vehicle.

Furthermore, in accordance with some embodiments of the present invention, the processor is to calculate a velocity of the vehicle at a point between the first location and the second location, and to predict a time of arrival of the vehicle at the second location.

Furthermore, in accordance with some embodiments of the present invention, the system includes a memory, the memory to store a velocity of the vehicle at a point between the first location and the second location, and wherein the processor is to compare the velocity to a prior velocity associated with the point.

Furthermore, in accordance with some embodiments of the present invention, the processor is to compare the velocity of the vehicle at the point with a prior velocity of the vehicle at a second point between the first location and the second location.

In some embodiments one or more instances of as location of a first said sensor encompass access or entry points of a vehicle to an area covered by the system.

In some embodiments a system may include a memory that is suitable to store a time interval of a vehicle's travel between a first location such as a location of a station with a first sensor and a second location such as a location of a second sensor, and the processor is suitable to compare the stored time interval to a prior time interval associated with travel between the first location and the second location.

There is further provided, in accordance with some embodiments of the present invention, a method for vehicle monitoring, the method including: operating a sensor to automatically identify a vehicle at a first time at a first location; determining a characterizing feature of the identified vehicle; operating an imager to acquire an image at a second time at a second location; and if the acquired image includes the characterizing feature, predicting a location of the vehicle.

Furthermore, in accordance with some embodiments of the present invention, the sensor includes a license plate reader and identifying the vehicle includes reading a license plate of the vehicle.

Furthermore, in accordance with some embodiments of the present invention, the sensor includes an RFID reader and identifying the vehicle includes reading an RFID tag of the vehicle.

Furthermore, in accordance with some embodiments of the present invention, determining the characterizing feature includes acquiring an image of the vehicle concurrently with identifying the vehicle.

Furthermore, in accordance with some embodiments of the present invention, determining the characterizing feature includes retrieving the characterizing feature from a database.

Furthermore, in accordance with some embodiments of the present invention, the first location includes an access point to a neighborhood.

Furthermore, in accordance with some embodiments of the present invention, the second location includes a vicinity of a residence.

Furthermore, in accordance with some embodiments of the present invention, predicting the location includes determining an expected time of travel from the first location to the second location.

Furthermore, in accordance with some embodiments of the present invention, the method includes issuing an alert when the vehicle is predicted to be at a location that is not expected for that vehicle.

### BRIEF DESCRIPTION OF THE DRAWINGS

To better understand the present invention and appreciate its practical applications, the following Figures are provided and referenced hereafter. It should be noted that the Figures are given as examples only and in no way limit the scope of the invention. Like components are denoted by like reference numerals.

FIG. 1 is a schematic illustration of a vehicle monitoring system, in accordance with embodiments of the present invention.

FIG. 2 is a flowchart depicting a method for vehicle monitoring, in accordance with an embodiment of the present invention.

FIG. 3A shows a mailbox camera in accordance with an embodiment of the present invention.

FIG. 3B is a side view of the mailbox camera shown in FIG. 3A in accordance with an embodiment of the present invention.

FIG. 3C is a cross sectional view of the mailbox camera shown in FIG. 3A in accordance with an embodiment of the present invention.

FIG. 4 shows the field of view of the camera shown in FIG. 3A in accordance with an embodiment of the present invention.

FIG. 5A shows a window camera installation in accordance with an embodiment of the present invention.

FIG. 5B shows a cross section of the installation shown in FIG. 5A in accordance with an embodiment of the present invention.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Embodiments of the invention may include an article such as a non-transitory computer or processor readable medium, or a computer or processor storage medium, such as for example a memory, a disk drive, or a USB flash memory, encoding, including or storing instructions, e.g., computer-executable instructions, which when executed by a processor or controller, carry out methods disclosed herein.

In accordance with embodiments of the present invention, a system is configured to track or trace the path or presence of an identified vehicle (e.g. an automobile, bus, motorcycle, etc.) within a monitored area using simple imaging or sensor devices (e.g., inexpensive cameras or video cameras designed for a home security system). The position of the vehicle may be traced, tracked or predicted (e.g., a probable or most likely position of the vehicle is calculated or given) on the basis of one or more characterizing features of the vehicle that are subsequently identified within an acquired image of the vehicle. The characterizing features may be common to two or more identified vehicles, and may include a visible characteristic, such as size or color, as illustrative examples, but may also be as general as simply identifying an object in a camera's field of view as a vehicle. The monitored area within which the vehicle is tracked may include, for example, a residential neighborhood, a gated community, an industrial park, a shopping center or commercial zone, or another area with a limited number of access points.

At least one station is provided at one or more locations within the monitored area. The station is provided with a capability to automatically and positively identify a vehicle, e.g., in the form of a first sensor. The station may be located at an access point to the area within which the location of the vehicle may be tracked. For example, a station may be located at a gate through which the vehicle must pass in order to enter the area or at another point or area where the vehicle must or will likely pass. For areas with multiple entry points for a vehicle into the area, e.g., having multiple entrances and exits, multiple stations may be utilized capturing all or the majority of traffic into or out of the area (to encompass the set of entry points of a vehicle into the area). The station may include a sensor or device for unambiguously and uniquely identifying a vehicle. For example, the station may include a license plate reader, e.g., in the form of a camera that is suitable or aimed to image (e.g. capture the image of) the license plates or tags or other unique identifier of each vehicle that enters or passes the station. Alternatively or in addition, the sensor may include a radiofrequency identification (RFID) device for reading an RFID tag of or on the vehicle, a wireless communication device for communicating with a wireless device on the vehicle, a scanner for reading a bar code that is printed on the vehicle, or another sensor that is capable of reading or interacting with a cooperating identifying structure or devices on the vehicle. The station may be configured to indicate a time at which the vehicle was identified.

One specific method of identifying a vehicle entering an area that is of interest is by means of Global Positioning System (GPS) tracking of a device associated with a vehicle or a passenger in a vehicle. For example, GPS information from a vehicle or passenger's GPS device may provide a time series history of location of that vehicle or passenger, or it may provide intermittent information about the location of a vehicle or passenger, such as it may be prompted by RF communications to provide its position at certain times, or in certain positions. In this case, a station may be a “virtual” station at the entrance to a neighborhood, where no physical station may be present, but information associated with the presence of an identified vehicle may be collected or provided. For further clarity, in the case of identification using the GPS of a passenger in a vehicle, the vehicle may be less-than-uniquely identified (for example if a driver may use one of two cars) and in all cases in this application, the term “passenger” may refer to a driver of a vehicle or a non-driving passenger.

For clarity, the station may not be capable of uniquely identifying all vehicles under all circumstances. For example, in periods of heavy rain, license plate readers may be inoperable. In addition, if RFID tags are utilized, not all vehicles may have a readable tag, and not all tags may be read in every instance. So in some cases, a vehicle may be identified as having passed, without positive identification of the vehicle being obtained, and such a vehicle may simply be identified as unidentified.

The station may include a second sensor that is suitable to capture a second identifier or characterizing feature of the vehicle. For example, the station may include one or more optical devices (e.g., video cameras, still cameras, spectrophotometers, or other optical device) that are capable of determining one or more characterizing features of the identified vehicle. Characterizing features may include, for example, a color of the vehicle, a pattern on the outer surface of the vehicle, a shape of the vehicle or of one or more regions of the vehicle, or another visible characteristic or distinguishing feature of the vehicle. Alternatively or in addition, a processor that is associated with the system or with the station may access a database of vehicles. The database may include a table of characterized, recognized, authorized otherwise known vehicles. The database may associate one or more characterizing features with a particular identified vehicle.

For clarity, the station may not be able to identify specific characterizing features of the vehicle beyond simply recognizing that a vehicle is present. Even the knowledge that any vehicle has passed can be of significant utility in evaluating the security of an area, as is described in further detail below. In some embodiments, no camera may be utilized at a station, and only RFID readers may be utilized to positively identify vehicles that have RFID tags. Alternatively or additionally, audio sensors may be utilized to identify the passage of vehicles, or to determine an audio signature for a vehicle.

Note that multiple means of identification may be compared at a station to more reliably identify a vehicle. For example, a license plate reader may be used first to positively identify a vehicle on a clear day. An RFID tag read concurrently during visits to the neighborhood may then be associated with the previously read license plate, and an audio signature for the vehicle may be recorded. On a rainy day, when the vehicle's license plate may be illegible, the RFID tag may be utilized to identify the vehicle, or if the RFID tag fails on a rainy day, the acoustic signature may be of utility in predicting the location of a vehicle. Similarly, GPS data associated with a vehicle or passenger may provide still another perspective to inform and predict the movement and location of a vehicle.

After passing the station, an image of the vehicle may be captured or acquired by an imaging device or imager that is remote from (located at a different location than) the station. For example, the vehicle may be imaged by a home security camera or by another simple security camera, or a camera that is simpler or less suitable for identifying the unique identifier than is present at the sensor at the station. The imager or some other component may be configured to indicate a time at which image was captured.

A processor of the system may analyze the image. The analysis may identify the characterizing feature of the vehicle in the image that is captured by the more simple security camera. Identification of the characterizing feature in the image may be interpreted as indicative that the imaged vehicle is the vehicle that is identified in the image. Thus, a prediction may be made of the location of the vehicle based on the acquired image. (As used herein, a prediction refers to an indication of a location or presence of the vehicle based on data previously gathered about the vehicle and its location).

For clarity, the characterizing feature of a vehicle may not be highly distinguishing from other vehicles, and in some cases, may be as ambiguous as simply identifying that there is a vehicle in the field of view of a camera. Nonetheless, in certain cases, reasonable predictions may be made about the identity of a vehicle. For example, when an identified vehicle pulls into a neighborhood, and then a short time later pulls into the driveway associated with its owner, there is a high likelihood that the owner's vehicle just returned home. Thus, a prediction nay be made that the two detections that were made by the two sensors in different locations are both of the same vehicle.

On the other hand, the image obtained at the imaging device may provide further information that may be useful in the identification of characterizing feature in an acquired image of a vehicle, without definite identification of the vehicle. For example, a security camera may record a shape or color of a vehicle, but not the vehicle's license number.) In addition, it should be noted that the timing of the motion of a vehicle may also provide important information about a vehicle's identity (as in the case of a vehicle returning home in the prior example), so that when the term “characterizing feature” is used in this document, it should be understood to encompass the time of observation or other patterns of the vehicle's use or path in the area, as a possible characterizing feature in the specifications and heuristics that follow.

Further analysis of the image may yield a motion of the vehicle. For example, such further analysis may indicate that the vehicle is traveling with a particular velocity (direction and speed), is stopping or parking, or is being maneuvered in a particular manner. Images of the vehicle may be acquired sequentially by two or more imaging devices within the monitored area. Analysis of a currently acquired image may include checking for consistency of a currently predicted location of the vehicle with a previously predicted location of the vehicle (e.g., determined from a previously acquired image of the characterizing feature). For example, a currently predicted location of the vehicle may be checked for consistency with a previously predicted location and velocity of the vehicle. A processor may be configured to predict a time of arrival of the vehicle at a particular imager. The processor may be configured to compare a time interval for travel of the vehicle between two locations and a prior (e.g., measured or calculated on a previous occasion) time interval for travel of the vehicle or another vehicle between the two locations. The processor may be configured to calculate a velocity (e.g., an average velocity) of the vehicle for travel between a first location and a second location. The processor may be configured to compare the calculated velocity with a prior or subsequent measured or calculated velocity of the vehicle at point between the first and second locations. Patterns of location or movement of a vehicle within a movement may also be tracked an compared to for example known patterns of such vehicle or to suspicious patterns of movement. Such consistency checking may, in some cases, enable association of an imaged characterizing feature that is common to two or more identified vehicles with one of the vehicles. Increased density of imaging devices within the monitored area may enable more accurate association of the characterizing feature with one of the identified vehicles.

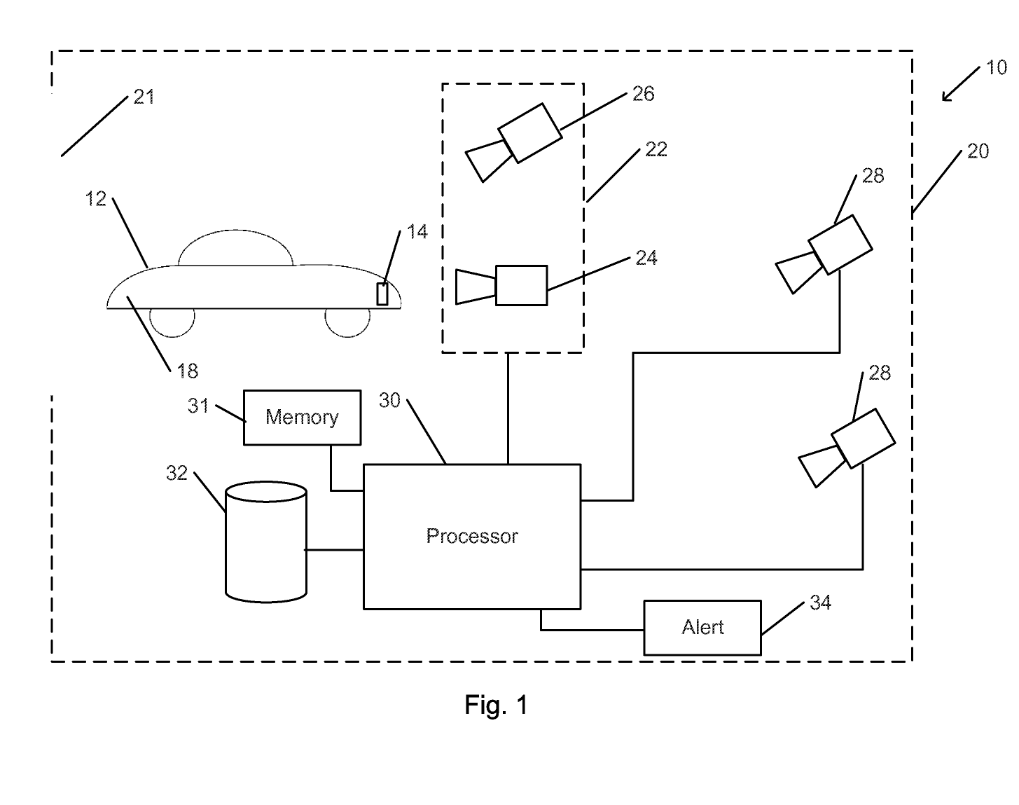

FIG. 1 is a schematic illustration of a vehicle monitoring system, in accordance with embodiments of the present invention.

Vehicle monitoring system 10 monitors a vehicle 12 when vehicle 12 is within monitored area 20 (e.g., a neighborhood, industrial or commercial zone, or other defined region within which vehicle traffic is to be monitored). Vehicle 12 includes identifier 14. For example, identifier 14 may include a license plate or vehicle tag, an RFID tag or chip, a transmitter, a GPS device associated with the vehicle or driver, or other device or component that is configured to identify vehicle 12.

Vehicle 12 may include a characterizing feature 18. Characterizing feature 18 may include a visible feature of vehicle 12 that may be visible in an acquired image of vehicle 12. For example, characterizing feature 18 may include a color, pattern, shape, or other visible feature of vehicle 12, or it may be as general as simply being identified as a vehicle passing at a specific time. Characterizing feature 18 may be common to two or several vehicles (e.g., to similarly colored vehicles or to automobiles of the same make or model).

Vehicle monitoring system 10 includes identification station 22. For example, identification station 22 may be located near access point 21 (e.g., gate, entrance ramp, toll booth, or other access) to monitored area 20. In the event that monitored area 20 includes a two or more access points 21, each access point 21 may be provided with a separate identification station 22.

Identification station 22 may include identification device 24. Identification device 24 is configured to read or communicate with identifier 14 of vehicle 12. For example, identification device 24 may include a camera that is aimed to read a license plate or vehicle tag, may include a

RFID transceiver for reading an RFID tag, a receiver for receiving a wireless signal that is emitted by identifier 14, or other device for identifying identifier 14.

In the case of identification of a vehicle by GPS tracking of a device on board and associated with the vehicle or a passenger, the identification device 24 may be understood to be the GPS tracking system associated with the device, which may be understood to be the identifier 14, in this case.

Multiple devices may be utilized to infer the likely identity of a vehicle at a particular location. For example, a camera may identify whether or not a vehicle enters a driveway, while an RFID reader may determine if the vehicle is carrying a known RFID tag. In the event that an unknown vehicle enters a driveway, the RFID reader may not be able to determine that any car has entered, due to a lack of an RFID tag, but the camera's input coupled with the RFID tag can confirm an unknown vehicle has entered, and additional data from a station at an access point may provide further information.

Identification station 22 communicates with processor 30. For example, identification station 22 may communicate with processor 30 via a wired or wireless communication channel. Processor 30 may include a plurality of intercommunicating processing devices. Processor 30, or components of processor 30, may be associated with vehicle monitoring system 10, with identification station 22, or with other components of vehicle monitoring system 10 (e.g., with individual home, office, or building security systems). Processor 30 may access database 32. For example, database 32 may be stored on one or more data storage devices with which processor 30 may communicate. Database 32 may include access to data at a remote location, e.g., at a neighborhood security center, motor vehicle licensing facility, a law enforcement facility, or at another external location.

Processor 30 may access memory 31. Memory 31 may include one or more volatile or non-volatile memory devices. For example, memory 31 may be used to store one or more of a detected vehicle identification, and acquired image of a vehicle, a time of detection or acquisition, a time interval between detection of a vehicle at first location and at a second location. Memory 31 may be utilized to store programmed instructions for operation of processor 30, data that is utilized in operation of processor 30, or a result of operation of processor 30.

Identification data that is acquired by identification device 24 may be analyzed by processor 30. For example, processor 30 may query database 32. Querying database 32 may return data related to the identification data, such as an identification of the vehicle 12 with which identifier 14 is associated. For example, the returned data may include a description of a characterizing feature 18 of a vehicle 12, an owner or operator of a vehicle 12, or other data related to a vehicle 12.

Identification station 22 may or may not include imaging device 26. For example, imaging device 26 may include a still or video camera operating in the visible or infrared spectral ranges (or in another spectral range). Imaging device 26 may acquire one or more images of vehicle 12. Acquired images may be analyzed by processor 30. Analysis of the image may identify one or more characterizing features 18 of vehicle 12. For example, analysis may yield a characterizing color, pattern, or shape. The returned data may be compared to the identification data collected by the imaging device to for example confirm the identification of vehicle 12. Such identification data may be associated with the returned data from the data base or as captured by imaging device 26.

In the event that identification station 22 does not include imaging device 26, the identification station may utilize other means to identify the presence of a vehicle, or an identifying characteristic of a vehicle. For example, an RFID reader may be utilized to positively identify a vehicle. Alternative means of identifying the presence of a vehicle, such as a motion detector with an appropriate field of view, or an auditory sensor, may be able to identify the fact that a vehicle is present, and may be able to provide additional identifying characteristics (such as an acoustic signature).

As vehicle 12 travels within monitored area 20, vehicle 12 may approach one or more imaging devices 28. For example, an imaging device 28 may include a privately or publicly operated security camera operating in the visible or infrared spectral ranges, a traffic monitoring camera, or another imaging device. An imaging device 28 may include a handheld (e.g., by security or maintenance personnel, or by other people within monitored area 20) or otherwise portable camera that is in communication with processor 30. An image that is acquired of a vehicle by an imaging device 28 may be analyzed by processor 30. Analysis of the image may identify a feature in the image that corresponds to a characterizing feature 18 of vehicle 12. Processor may then predict the position of vehicle 12 based on a known position of the imaging device 28 that acquired the image.

Analysis by processor 30 of images acquired by one or more imaging devices 28 may reveal suspicious, unusual, unexpected, atypical, or otherwise notable activity by a vehicle. In some cases, an alert device 34 may be activated to issue an alert to an appropriate party. For example, the appropriate party may include security or maintenance personnel, an owner of a vehicle 12, an owner or manager of a property in the vicinity of the notable activity, For example, an alert on an alert device 34 may include a visible or audible alarm or message, or another type of alert.

For further clarity, a feature to be associated with a vehicle may be identified not only by the automated system, but also by interaction with a user or a monitoring company. Specifically, if an alert is sent to a user or monitoring company, the alert may include photographic or video footage of a vehicle. The footage may be utilized by a user to identify the vehicle, a person associated with a vehicle, or a risk level. For example, a homeowner may identify a vehicle as “Aunt Jane's Car” or a monitoring company may identify a vehicle as a “suspicious vehicle”. Features associated with vehicles and identified by users may be stored in a database, and accessed in future visits by a vehicle in predicting the vehicle's location.

As is illustrated in the case above, features of a vehicle may also relate to previously established patterns of travel of vehicles. For example, a vehicle may be associated with a particular property. When two cars enter a neighborhood, one may be identified as being associated with a property, which is subsequently entered by one of the vehicles, which can inform the predicted location of the other vehicle. In some embodiments, two or more vehicles may pass a gate or station, and each or at least one of such vehicles may be identified by a system by way of for example, a license plate identifier or some other unique identifier. Some or all of such vehicles or their identifiers may be associated in a memory of a system with an expected direction, path, location or destination of a trip in a particular area. For example, a first vehicle may be associated with a first address and a second vehicle may be associated with a second address. If the system identifies a first car in an expected location for such car, the system may infer and predict that the second car is not the first car. If the system identifies a first car as not in its expected location, the system may infer that a second car that is in an expected location may be the second car as passed by the station. In another example, a first car may be associated with a first address, while a second car may not be recognized by the system and may therefore not be associated with an expected address or location. A sensor located remotely from the station may identify a first of the vehicles as being on its expected path or at its expected location. A system may infer that the second vehicle is not the first car.

Processor 30, alone or in combination with other processors, may be configured to carry out embodiments of the invention by for example executing software, code or instructions stored in database 32.

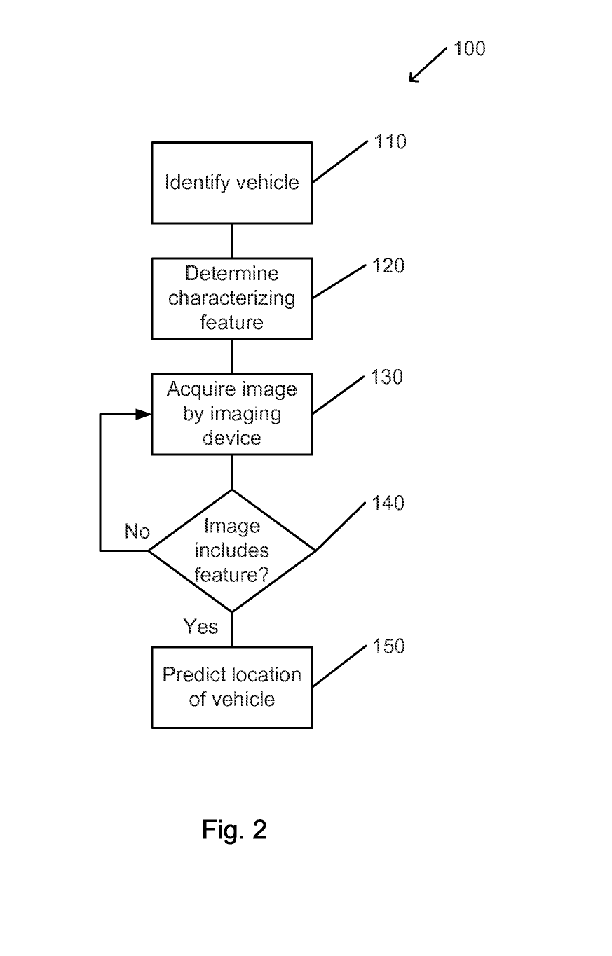

FIG. 2 is a flowchart depicting a method for vehicle monitoring, in accordance with an embodiment of the present invention. Reference is also made to components of the vehicle monitoring system illustrated in FIG. 1.

Vehicle monitoring method 100 may be performed by processor 30 of vehicle monitoring system 10. However, other or different equipment may be used with methods according to embodiments of the invention. Vehicle monitoring method 100 may be initiated when a vehicle 12 is detected as entering monitored area 20.

The vehicle may be identified by a sensor at a station (block 110). For example, an identifier 14 of vehicle 12 may be identified by identification device 24 of station 22, in cooperation with processor 30 and database 32. In the event that the vehicle cannot be positively identified (for example in the case of a thief obscuring a license plate), the vehicle may be identified simply as an unidentified vehicle. The time of identifying the vehicle may be noted.

A visible characterizing feature 18 of the vehicle may be identified (block 120). The feature may be identified by analyzing an image acquired by imaging device 26 of station 22. Alternatively or in addition, a characterizing feature 18 or other associated feature (such as the location of a residence associated with a vehicle) may be retrieved from database 32.

Images are acquired by one or more imaging devices 28 (block 130). Imaging devices 28 are located at locations that are remote from station 22. The time of acquisition of each image may be noted, e.g., recorded in database 32 or some other memory unit. The various imaging devices may operate concurrently to acquire images for analysis by processor 30. If analysis of the acquired images does not reveal characterizing feature 18 (block 140), acquisition of images continues (block 130); however note that the characterizing feature may be as general as the presence of a vehicle at a given point in time.

The characterizing feature 18 may be detected in an acquired image (block 140). A location of vehicle 12 may then be predicted. For example, the location of the imaging device 28 that acquired the image, and a direction in which imaging device 28 was aimed when the image was acquired, may be reported to processor 30. Processor 30 may, on the basis of the reported data, and assuming that the detected feature belongs to vehicle 12, predict a position of vehicle 12.

Analysis of a series of acquired images over a known time interval may yield a velocity of vehicle 12. Utilization of previously predicted positions of vehicle 12 may be utilized to resolve an ambiguous identification of the vehicle. For example, two or more vehicles may share a common characterizing feature 18 that is detected in an acquired image. Analysis of previously predicted motion of each of those vehicles, may, in some cases, determine which of the vehicles was traveling in the determined velocity such that the vehicle was likely to arrive at imaging device 28 when the image was acquired.

In some cases, processor 30 may determine that, on the basis of a predicted location or motion of vehicle 12, or in the absence of clarity on the predicted location of a vehicle, an alert is to be issued. In this case, processor 30 may operate alert device 34 to issue an appropriate alert.

The system and method described herein provide for enhanced security at a residence, through the use of data gathered remotely from the residence, which may include tracking data from the Global Positioning System (GPS), through cameras which may be located in the vicinity of the property being monitored, and from other sources that are not permanently installed at the property. This data may advantageously be shared in a controlled manner among multiple property owners within a neighborhood, or across multiple neighborhoods or locations within an area.

In some embodiments, a GPS or cellphone may be detected in a proximity of a vehicle that is identified with a unique identifier at for example a station. One or more of the detected cellphone or GPS may be associated with an address in an area covered by the system. The detected cellphone or GPS device may be detected at for example an address that is associated with the unique identifier of the vehicle. When the cellphone or GPS is detected at such address, the system may infer that the vehicle that arrived at such address was the vehicle that is associated with the address.

A home may be located within a neighborhood of residences. Video data may be of utility in protecting a home, whether gathered at the level of a home or a neighborhood. The data may be analyzed by a machine vision system to create metadata about objects captured in the video streams, and the metadata may be captured and recorded along with the video data, and then analyzed by an analysis module, which may consider a combination of data gathered from one or more sources, which may include video sources and other data sources.

Machine vision systems are commercially available today from a variety of sources, such as those provided by Cognex, Agent Video Intelligence, VideoIlQ or Epic Machine Vision. Such commercially available systems are capable of taking patterns of video input (such as a car passing) and deriving associated metadata (such as the speed or size of a vehicle). For clarity, all references to video data herein may refer to either video data gathered in the visible spectrum or in the infrared

(IR) spectrum, the latter of which may provide for thermal imaging or enhanced visibility during periods of darkness (also known as night vision). The two types of imaging (in the visible and IR spectrum) may also be useful when combined in certain instances.

The video data may include internal images within a residence, external views of a homeowner's property, views of driveways and walking paths that approach a residence, and views of a street in the neighborhood of a residence. In particular, external views of streets and driveways may be configured in such a way that the video camera is positioned to pass the necessary views to a machine vision system capable of extracting identifying features of vehicles, such as a license plate, make, model, color and/or physical dimensions; or extracting identifying features of passengers in vehicles, such as the number of passengers, the orientation of a driver or passenger's eyes, the size or gender of passengers, facial images may also be stored or analyzed for the purpose of facial recognition and positive identification.

In particular, license plate recognition systems are commercially available today. For example, Sony and Bosch offer day/night cameras with high intensity infrared light-emitting diodes (LEDs) capable of providing license plate identification at distances of up to 200 feet in complete darkness.

Data included in the assessment of security risks may include data from GPS associated with specific devices owned or controlled by neighborhood residents. As an example, a resident may grant the security system the authority to track his cell phone via GPS tracking, or to track his car's GPS system. The data provided to the security system by these devices may inform risk assessments without the installation of any additional equipment in the neighborhood, and may be utilized advantageously in combination with data from local monitoring efforts, as described below.

Data from other sources may also be considered in the risk assessment process. These other sources may include data from other residential security measures, such as door-mounted entry sensors and motion detectors. Data sources may additionally include feeds from RFID tags on vehicles, information from security systems at other properties in the neighborhood, data feeds from public safety authorities and data feeds from private security companies.

The time-based combination of these data feeds may be utilized advantageously to identify potential security threats and to alert the homeowner, neighbors and authorities.

In various embodiments, one or more cameras may be mounted at a property to enhance the security of a residence. Cameras may be mounted on the interior or exterior of a residence. In one embodiment, one or more cameras may be mounted to the inside surface of a window with an exterior view of an entrance path to the home, which may include a driveway, or a walkway 30 to one of the entrance doors. A camera may be afforded a clear view of a driveway or one or more pedestrian entrance paths, and additionally, there may be facilities on the camera to permit panning, zooming to further enhance observations.

Because windows can introduce issues of reflectance, it should be understood by one skilled in the art that a camera may be mounted on either the interior or exterior of a window, and if mounted on the exterior of a window, it may be held in place by magnets, adhesives, suction or other means, and it may be powered by electrical induction of power through the window.

A camera may have additional illumination provided, and such illumination may be switched to provide illumination in response to darkness, motion or a risk assessment. Illumination described herein and provided in accordance with the principles of this invention may be in the visible spectrum or the infrared (IR) spectrum, as may be appropriate to the installation.

In addition, the use of structured light sources may be of value in identifying physical features of passing vehicles. Structured light refers to a structured array of either visible or invisible projected light, often in the form of one or more lines or dots, which when superimposed on a three dimensional object may be utilized to generate a three-dimensional (3D) model of such an object. The use of structured light to generate three dimensional models is well established in the literature, as described by “Structured-light 3D surface imaging: a tutorial”, Jason Geng, Advances in Optics and Photonics, Vol. 3, Issue 2, pp. 128-160 (2011), hereby incorporated in its entirety by reference.

A camera may communicate wirelessly with a security system in the home, which may communicate over a network, such as the internet, with a local security network at the property and/or a remote security network. The camera may have on-board machine vision processing capability, or the camera may be linked via a wireless, a wired or a combination of wired and wireless networks to a computer with machine vision capability.

Such machine vision capability may permit the camera to identify specific features of a property, such as the areas of driveways or walkways. Particular aspects of the machine vision capabilities may be enhanced through configuration by the user, a remote technician, a local installer, or by default logic. For example, the boundaries of a driveway may be initially identified by the machine vision module based on a dark patch in the field of view of the camera of consistent dark grey color. A street crossing at the end of the driveway may or may not be similarly identifiable, or may be identified on the basis of traffic patterns observed.

The position of these property features may be confirmed by presenting the homeowner with a visual diagram of the computer model of a home feature, such as a driveway, by overlaying a set of lines and/or curves representing a boundary of the driveway on an image of the driveway. In the event that the machine vision derived bounds of a driveway or path are not what is desired by a homeowner, a tool may be provided that allows the homeowner to adjust such boundaries. A similar tool may be provided to allow a homeowner to add pedestrian paths of entry that may be of concern to the homeowner to an image by drawing a set of lines and/or curves representing a boundary.

Machine vision capability may also allow the system to identify vehicles and features of vehicles such as, but not limited to license plates, make, model, color, length, height, width, the number of passengers, the orientation of eyes of a driver or passengers, and whether lights on the car are illuminated. This machine vision capability may include the combination of features observed in the IR spectrum with features observed in the visible spectrum, such as identifying the exterior color of a car through visible spectrum camera, and obtaining information on passenger counts with thermal imaging of passengers. Thermal imaging may also be useful in identifying the size or type of an engine through thermal imaging of the hood of the car or the exhaust pipe (any of which may also serve as a characterizing feature). These pieces of information may be combined to provide a more detailed assessment or identification of the car for future reference.

The speed of vehicles may be assessed through observations of a vehicle across multiple frames of video from a single camera, or by comparing the elapsed time between the car's visible presence at two locations in view of two different cameras.

Machine vision may also allow the system to identify people, to measure physical dimensions of individuals, to observe the direction of eye movements, or to recognize faces or gestures, as examples. Machine vision may also allow the rate of travel of individuals to be tracked and included among the metadata that is analyzed by the system, in a manner similar to what has been described for vehicles. As with vehicles, the machine vision associated with individuals may be enhanced during the period of system configuration, for example by having a resident stand in front of the camera, so that the system can learn to recognize a resident on the basis of physical identification characteristics.

The recognition of specific features, identifiers, speeds and other data associated with pictures may be stored as metadata associated with those video images, with storage occurring at the camera, at a computer in the residence, or in a remote database in network communication with the residence.

As part of configuring a system, events may be simulated by the homeowner, such as walking down an entrance path, or pulling a car into the driveway. The camera may include machine vision algorithms, which permit the device to learn certain patterns of images that may be of particular concern, which may include, but are not limited to: the entry of a car into a driveway, the presence of a person on an entry path, the speed of a car in a driveway, or the speed of a person on an entry path. These events may be video-recorded at different times, such as during daylight, dusk and during evening hours, and these events may be recorded under different conditions, such as a car entering the driveway at night with lights on, or a car entering the driveway at night with its lights dimmed.

In addition to the aforementioned logic related to assessing security risks associated with particular vehicles, the movement of pedestrians on a property may also provide important information useful in risk assessment. For example, the level of alert provided when a vehicle turns around in a driveway may differ from the level of alert that is appropriate when a pedestrian exits an unknown vehicle and approaches a vacant home.

Some of the events described above may be simulated by the homeowner to ensure the system is properly configured and calibrated, and has the proper context for interpreting visual indicators at that home; others may be based on machine vision logic developed over simulations at a number of homes.

Additional events occurring near the home may also be simulated or monitored in this manner. For example, in the case where the camera may have a view of the end of a driveway, it may be possible to observe a car passing the driveway. In the case that the end of a driveway is not visible from the home, an additional remote camera may be mounted outside, to a lamppost or mailbox to provide a view of the end of the driveway, or at another location providing a suitable view.

In one embodiment, a mailbox or lamppost may be a convenient place to mount cameras, as it often affords a view of the driveway at a point of entry, as well as a view of vehicles approaching from both directions. In particular, by mounting a single camera with a split view of both directions or multiple cameras to provide these multiple views, video images may be gathered to monitor and identify traffic passing as well as entering the property. While a mailbox may be a convenient way to mount these cameras, it should be understood that there are any number of potential ways in which such a camera or cameras may be mounted in order to provide suitable views. If a mailbox is utilized, it may have the additional benefit of being able to track the timing of the delivery of mail, and delivering notification to a homeowner of mail delivery.

Whether a camera may be mounted on a mailbox, in a home, or at some other external 25 location in the environs of a home, if a view of the street is available, that may provide certain advantages. In the event that a view of the end of the driveway is achievable, events such as a car driving by the end of the driveway may be monitored. For both views of the end of a driveway, and for views of cars entering the driveway, features of cars passing into the view of the camera may be evaluated by a machine vision system. These features may include, among other potential examples, the identification of the car's license plate, the make, model and color of the vehicle, the height, width and length of the vehicle, whether the vehicle's lights are illuminated, the number of passengers in a car, and/or the orientation of a driver and selected passengers heads within the vehicle.

Methods of conducting such types of identification have been explored by a number of researchers. A number of methods are described below, and such references are hereby incorporated in their entirety by reference. The license plate can be located on a moving vehicle using established methods, such as those described by Saeed Rastegar in the International Journal of Image Processing (IJIP), Volume 3, Issue 5, page 252, titled “An intelligent control system using an efficient License Plate Location and Recognition Approach”, whereby edges of a vehicle are identified, candidate regions for a license plate location identified, and finally the license is then read. For license plate identification in cases of poor weather or poor camera resolution due to distance, image processing logic such as has been described by as “A Robust Method of License Plate Recognition” by Anish Lazrus and Siddhartha Choubey of the Shri Shankaracharya College of Engineering & Technology in Bhilai India have proven helpful.

Information on vehicle make and models may also be obtained from image data. One example of how to do so is described in “Vehicle make & model identification using scale invariant transforms” The Seventh IASTED International Conference on Visualization, Imaging and Image Processing (VIIP '07, Pages 271-276), but it should be understood that there are any number of methods to create three dimensional models from two dimensional images.

It also should be understood that additional information may be garnered on these two-dimensional images through the combination of several views. Specifically, as a vehicle drives past a camera, the angle of view changes, providing different perspectives on the same vehicle, which can advantageously be combined in order to create a three dimensional view. In addition, the use of multiple cameras (such as on either side of a mailbox, facing in opposite directions), can provide further data and additional perspectives on specific features of any vehicle. Finally, stereoscopic imagery on either side of a mailbox or other camera installation may provide additional information, which may be useful in constructing three dimensional models of vehicles which may be then compared to vehicle databases containing specifically identifiable features.

Identifying whether lights are illuminated on a moving vehicle has not been a focus of the prior art in the security space, which has largely focused on government and institutional needs, but can provide significant indications of a vehicle's intent in residential settings. However, the methods described above for plate identification, in terms of identifying likely spots on a vehicle, as well as the reference above for vehicle make and model identification may readily be adapted to identify the location of lighting fixtures on a vehicle. Once the location is identified, the determination of whether bulbs are lit is fairly straightforward, using standard imagery thresholds for contrast, and may be further enhanced through the use of IR thermography, which will show clear heat profiles from a vehicle's headlamps or tail lights.

Thermography, or IR imagery, may also be of particular use in identifying the number of passengers in a vehicle. Because the passenger compartment of a vehicle is normally at a distinctly lower temperature relative to body temperature, even at night, the IR emissions from a driver or passenger will be readily apparent outside of a vehicle to an IR camera, allowing passengers to be counted, even when visible light does not penetrate the car well at night. Once a model of a vehicle has been constructed using the aforementioned techniques, the expected location of a driver and passenger can be inferred. The presence of warm bodies in the driver and passenger seats may then be utilized to provide a count and size of passengers, which may provide further information for security assessments.

In a manner similar to those utilized to match an images of a vehicle to specific makes and models, imagery of the heads of passengers or drivers of vehicles may be compared with a set of generic faces, containing the normal features of eyes, ears, nose, mouth and neck, with such models representing the large majority of the human population. A “best fit” model may be created of the three-dimensional size, shape and orientation of a passenger in this manner, whether the imagery source originated in the IR or visible spectrum, or even a combination of both sources of data was used.

As this model converges, the orientation of the head may be determined at any point in time. In other words, as a head rotates, the nose, which was at one point apparent in a profile view, may shift to a front view perspective. Accordingly, at any point in time one may be able to determine the direction a driver or passenger is facing. This may provide important clues useful in the judgment of security risks, such as the case of two full sized males driving slowly past the end of a driveway, with the orientation of their heads indicating they may have their eyes fixed on a home, rather than the road in front of them, which could be indicative of “casing” a home.

The aforementioned methods reference various ways of building solid models of moving objects from a series of two dimensional images taken from one or more cameras. Yet another reference in this field is the software VideoTrace, which is capable of building realistic 3D models from a series of 2D views of objects, such as cameras provide. That particular software requires a user to identify the boundary of the object to be modeled in three dimensions, and such a boundary may be automatically generated through the use of two filters: a first filter for identifying pixels that are not in a “normal” state, which is reflective of the image observed by the camera when nothing is in view, and a second filter that then looks for sharp contrast in color at the boundaries of an object that is moving through the field of view. To clarify, as a car or person moves through what was previously an empty space, the subject person or vehicle is identifiable by the disruption of the normal background, and by color contrast at its edges, which then is used to provide the boundaries of an object for subsequent three dimensional modeling.

In addition to being able to identify the make and model of a vehicle on a street, similar methods of transforming two-dimensional data into three-dimensional models may be useful in gathering identifying information for the case of a human approaching a residence. For pedestrian entrances to the home, the machine vision system may be capable of identifying particular characteristics of individuals, which may include, but are not limited to height, girth, hair color, eye color and facial recognition. The physical dimensions of a subject may be determined by the aforementioned methods, and eye color and hair color are readily determined by the identification of the area of the body which is the eye or hair, and then straightforward measurement of color.

Facial recognition is a more complex task, but one that has experienced a surge in research in recent years. Companies such as BetaFace and Face.com (now part of Facebook) regularly identify subjects from a single two dimensional image, and offering multiple two dimensional views through video feeds may enhance the resolution and specificity of such identification methods. Bioscrypt Inc. has also developed a system for creating three dimensional facial models, and using that technology for driving facial recognition, which is commercially available at 3D FastPass.

Through various methods described below, the machine vision system may gather information on the arrival or departure of individuals and vehicles from the premises. In addition, the security system may combine information from the vision system from multiple camera locations, and may combine information with data from other sources for the purpose of enhancing risk assessment.

For example, many homeowners possess cell phones with GPS location capability. The cell phones may be programmed to provide a signal to the security system regarding their location. In one embodiment, data from the cell phone GPS signals may be combined with observations from the security system to assess the potential for a security issue.

A neighborhood, may contain a plurality of homes. Any given home may have a driveway, and a mailbox, along with one or more viewing windows with a view of the driveway, the street or other pedestrian access paths to the home.

A car may enter the neighborhood, and a GPS signal from a mobile device inside the car may produce a path in a GPS tracking system. The path may show the car traveling toward and parking at a particular residence. Inside that residence, a video camera located at a window or at a mailbox may record the entry of the car into the property.

A video feed gathered from a window, mailbox or other mounting location may be passed to a machine vision system. The machine vision system may be capable of identifying the entry of a vehicle or person to the property, and may specifically be able to identify a vehicle entering a driveway, or a pedestrian entering a walkway.

The machine vision system may then consult with a GPS database, with GPS time series data associated with specific residents or other trusted persons associated with the property. If the GPS database provides information confirming the return of a trusted person to the property, the system may disarm or may disarm other security measures on the property. If the entrant to the property is not recognized via GPS records, the system may alert the property owner to the arrival of a visitor. The property owner may have the ability or the option to view still footage or video footage of the entrant, and may elect to disarm the system, or to notify the authorities of a potential intrusion. Additionally, the property owner could speak with the potential entrant by phone before granting entry or making a decision, and the property owner could direct the security system to prompt the visitor to “Call (123) 457-7890 to speak to the property owner so that we may identify you.” Similarly, if the entrant is not recognized or the property owner is not reached by the notification system, the system may alert the authorities directly under certain pre-determined circumstances, or at a user's request.

As a further exemplary illustration of how data may be combined, several combinations of events are described below, and classified according to the potential security risk. Actions in response to a particular risk or level of risk may also be tailored appropriately, and may be configured by a default configuration, by remote personnel skilled in configuration, by a local installer, or by the homeowner through a computer or online interface.

The situations illustrated below are intended to be exemplary, and it should be understood that any number of situations, levels of risk assessment and actions may be appropriate to a given installation.

A camera may detect (e.g. capture images of) a car entering a driveway. Concurrently, a cell phone GPS may show a homeowner returning home. It may then be inferred that the homeowner is returning. This may be treated as a low risk situation and video footage may be saved for a relatively short time period.

A car may be imaged as entering a driveway. The cell phone GPS of a homeowner may show that the homeowner is at home. It may be inferred that it is most likely a welcome visitor, but possibly a threat. The security risk may be assessed as moderate. The property owner may choose to be notified in this instance via email. Video footage may be saved for a moderate time period.

A car may be imaged as entering a driveway. Cell phone GPS may indicate both homeowners are at remote locations. A potential threat may be inferred with high security risk. The homeowner, a monitoring company and/or the authorities may then be contacted by phone immediately.

It should be understood to one skilled in the art that not only may the immediate location of a GPS device provide clues as to the level of risk associated with a particular situation, but the time-history of GPS signals may also be relevant. For example, a resident whose GPS records show him as traveling in another state for a week is at a greater risk of theft, than a resident who has a pattern of frequent arrivals and departures on a daily basis from his residence.

There may be a number of possible interpretations of any set of observed data. These cases above are illustrative, and there are a much larger number of possible explanations of any particular situation. Nonetheless, they may be helpful to a reader in understanding the types of risks being assessed, or to an individual involved with configuring a system, as a means of weighing risk levels.

It should be understood that the levels of security risk included above are arbitrary, and could be on any scale, including qualitative descriptors (such as low, medium and high), color codes (green, yellow, orange, red, etc.) or quantitative levels of risk (such as on a scale from 0 to 10, 0 to 100, or 0 to 1,000). Risk may be assessed in parallel on multiple scales, for example, with one scale representing the risk to the property and another scale representing the risk to a neighboring property or the neighborhood in general. Notifications may be based upon a separate scale of risks from actions, and individual notifications or actions may be based on different scales of risk than other notifications or actions.

A small subset of potential actions is included above, as a means of illustrating this particular example, but one should understand that any number of potential actions may be taken.

These may involve doing nothing, specific protocols for recording, transmitting and storing visual and other data feeds, and various protocols for potential alerts, which will be explained further in the pages to follow.

Data obtained from cell phones may not be limited to GPS data, and may include WiFi communications and/or Bluetooth connections. In one embodiment, the home security system may communicate via WiFi with the cell phone of the homeowner. When the homeowner is at home, the system may confirm the presence of the homeowner through the presence of the direct WiFi signal. This may be redundant with information from the cell phone GPS providing the homeowners' location, but may provide further confirmation of the homeowners' presence. It should be understood that any one or combination of Bluetooth, WiFi and/or cell phone GPS signals may notify the security system of the homeowners' presence. Similarly, it should be understood that similar means may be utilized to identify the presence of a WiFi, Bluetooth or GPS device at a station, which may be located at an access point.

When the homeowner is determined to be present by any of these means, the security system may automatically adjust to a different state of monitoring. For example, the system may arm motion detectors when all homeowners' cell phones are observed by the system to have exited the premises. Additionally, the security system may disarm motion detectors when a homeowner's cell phone is observed to have entered the premises.

It should be understood that these methods of arming and disarming the system, or increasing or decreasing the level of risk associated with a particular set of sensor conditions may be user-configurable, may be configured by remote personnel, by a local installer, or by default settings. In particular, the presence of a phone on the premises may normally be considered to be evidence of the presence of a homeowner, but a homeowner who leaves a phone at home accidentally when heading to work may remotely signal the occurrence of this event (for example through an online interface, or by calling in a particular code), which may then alert the system to ignore the presence of the phone for a period of time.

Similarly, keys can be a secondary identifier of a vehicle's owner, and their location may be identified using various RF techniques. For example, an RFID tag may be affixed to the key chain, which is identified directly by the station. Alternatively, an RFID tag may communicate with another RF device in the vehicle, such as a cell phone. This other RF device may then communicate with the station, or may communicate directly with a central processor via a cell connection or other means of wireless communication.

Data from multiple cameras, from views of multiple areas, and/or relating to the speed of travel or timing of observations of vehicles may also factor into the risk assessment. Further examples are now given.

Two cars may enter a neighborhood, with one being identified by its license plate or an RF tag as belonging to a resident, “John Smith”. The other vehicle may not be associated with anyone in the neighborhood, but its license plate may be recorded. Approximately 60 seconds after the arrival of Mr. Smith's car, a car is observed entering Mr. Smith's driveway, and the processor may infer that Mr. Smith's car entered Mr. Smith's driveway, assuming that the 60 second delay is in the typical range of transit times historically observed for Mr. Smith. Approximately 90 seconds after the arrival of the other vehicle in the neighborhood, a car is observed entering Mrs. Jones driveway. Mrs. Jones and her husband were observed in their cars exiting the neighborhood earlier that day, and have not been observed re-entering the neighborhood at any point since. All other cars that have entered the neighborhood have moved in expected patterns, such as to their owners driveways. The system may then infer that an unknown vehicle has entered Mrs. Jones driveway, and evaluate this as a medium or high risk situation. The system may then provide Mrs. Jones a text alert or a phone call, informing her of the situation, and providing an image of the vehicle so that she can evaluate the risk. Note that in this case, there was no specifically identifying characteristic of the vehicle that entered Mrs. Jones driveway. The identifying characteristic was simply a car had entered her driveway, which had not been previously identified.

A car is imaged entering a driveway rapidly, and then reverses direction and exits. The homeowners are at remote locations. The car could be a driver using the driveway as turnaround, or potentially a thief casing the home. The system may assess a moderate security risk, and respond with an email sent to homeowner and by saving video footage for 7 days.

Video data may show that a car pulls past driveway slowly, then returns and enters driveway slowly, with lights dimmed, sits for a few minutes, and then a pedestrian approaches door. The homeowners may be at remote locations. The system may infer that a thief is potentially casing the home, and then approaching the door, and may judge this to be an extremely high risk. The homeowner, a monitoring company and/or authorities may be immediately phoned.

In cases where machine vision systems are capable of capturing specific data on particular vehicles, the tracking of these vehicles over time may provide additional data, which may be of utility in risk assessments. Specifically, the data analysis system may consider the prior approach of the vehicle to the residence in determining the potential level of risk, as is illustrated below.

An unidentified car not previously observed in an area may enter a driveway rapidly, reverses direction and exit. Homeowners are at remote locations. This could be a driver using the driveway as turnaround, or potentially a thief casing the home. This may be deemed to present a moderate security risk, and video footage is saved for an appropriate period.

A car that has previously pulled past driveway three times slowly on successive days enters driveway. Homeowners are at remote locations. This pattern may be highly indicative of a thief first casing and then preparing to enter the premises. This may be deemed to present an extremely high risk; the homeowner or authorities are immediately phoned or contacted, and video footage is saved for 7 days.

The time of day and/or the presence of lights on a car may also factor into consideration as to the nature of a threat. As a further exemplary illustration, the time of day may be factored into a risk assessment. Further exemplary illustrations are shown in the examples below:

At 1:00 PM, in the middle of the afternoon, a car enters a driveway at a normal rate. Cell phone GPS data shows the homeowner is at home. The system may infer that this is most likely a welcome visitor, and relatively unlikely to be a threat. The system may infer moderate risk and save the video footage 7 days.

At 1:00 AM, in the middle of a night, a car is sensed as entering a driveway very slowly, with lights out. Cell phone GPS data may show the homeowner is at home. The system may infer this is unlikely to be a welcome visitor, and potentially may be a threat. The system may infer high risk and alert homeowner or authorities.

The number of passengers in a car and their eye movements may also provide indications of a level of risk associated with a particular situation. A further exemplary illustration is described.

At 1:00 PM, a car is imaged as it pulls past a house slowly. The driver is the only passenger, and is seen to be looking ahead at road. A cell phone GPS shows that the homeowner is at home. The system may infer that this is simply a case of a driver moving slowly. This may be deemed to present a moderate risk, and video footage is saved 7 days.

At 1:00 PM, a car is imaged as it pulls past a house slowly with both the driver and a passenger focused on the home. Cell phone GPS shows that the homeowner at home. The processor may infer this may represent driver moving slowly, or could be two potential thieves casing home. The system may infer higher risk and notify the homeowner, a monitoring company, or the authorities.

In the foregoing description and in the description to follow, we describe the security system observing the entry and exit of homeowners, but it should be understood that the use of these methods may be readily broadened to include other authorized persons in a variety of home or business settings. For example, a caregiver such as a babysitter or a regular visitor such as a friend or family member may be an authorized person who the property owner may identify as a trusted party.

In this case, that party's cell phone may be included among the phones identified as trusted by the property owner, and the security assessments associated with the entry of a person carrying that phone onto the premises may be adjusted appropriately. It should also be understood that these methods could apply to a business, or a work facility, such that the word “home” or “residence” may apply to a business or employer, and the words “homeowner” or “property owner” may apply equally to other authorized persons who may include friends, neighbors, family members, employees, business owners, vendors, and so on.

Observations from cameras at other properties in the neighborhood, or at the entry to a neighborhood may also be of utility in assessing the level of risk of a particular event. One example of how this data may be utilized is described.

At 1:00 PM, a homeowner's camera shows a car entering the driveway for the first time. In a neighbor's camera, the same car is not observed. At the entrance to the neighborhood, the car entered the neighborhood for first time. Cell phone GPS shows homeowner is at home. The system may infer this is most likely a welcome visitor, and relatively unlikely to be a threat. The system may infer moderate risk; send email to homeowner and save footage for 7 days.

At 1:00 PM, car enters driveway for the first time. The same car drove through and stopped near multiple neighbors. This car has entered neighborhood for 30-60 minute durations 3 times in last week. Cell phone GPS shows that the homeowner is at home. The system may infer this is less likely to be a welcome visitor, and may potentially be a threat or someone casing neighborhood. The system may infer high risk and immediately alert home-owner or authorities.

Observations of entry in the residence may also be incorporated into the program logic, including information gathered by other means, including interior cameras, motion detectors, breaking glass sensors or proximity sensors at doorways. Note that the logic governing the entry into the home may be combined with some of the preceding or following logic elements, such as considering the time of entry.

At 1:00 PM, a car enters driveway for the first time. Entry observed at front door by sensor. Cell phone GPS shows homeowner is at home. The system may infer that this is most likely a welcome visitor, and relatively unlikely to be a threat. The risk is evaluated to be moderate; footage is saved for 7 days.

At 1:00 PM, car enters driveway for first time (meaning that this car has not previously entered this driveway). A pedestrian's entry into garage is observed. Cell phone GPS shows that the homeowner is at home. This is most likely a welcome visitor, but there is some possibility of a thief. The risk is evaluated to be moderate to high; the homeowner is alerted.

At 1:00 AM, in the middle of the night, a car enters driveway for the first time. A pedestrian's entry is observed into garage. Cell phone GPS shows that the homeowner is at home. The system may infer that this is most likely to be a thief. The risk is evaluated to be extremely high; the homeowner and authorities are alerted immediately.

For clarity, in the examples above (and in all other references to time in this document), it should be understood that there may be a significant difference in risk assessment between an approach to the residence during a weekday, as compared to on a weekend, just as there may be a difference in risk levels between a visitor approaching at night vs. during the day, and there may also be differences between specific days, such as Saturday and Sunday, or Monday and

Tuesday, as examples.

In addition, specific individuals' patterns of entry and exit may be permitted at certain times (and not others). For example, a sitter who regularly visits the house during the week may be permitted entry during the week, but the system may be configured so that the sitter visiting the house alone during the weekend prompts an alert to be sent to the homeowner.

A list of trusted individuals may be provided directly by a resident of a property or neighborhood, or such data may be derived from other sources. For example, a resident using a cell-phone GPS system in combination with this security system may also authorize the security company to treat their phone's contacts or social media contacts as “trusted parties”, or to treat those parties as representing a lower level of risk, with regard to notifications or alarms. In combination with a phone company, and with appropriate consents and privacy safeguards, the GPS data of that set of contacts visiting the home may then be treated with an appropriate level of risk assessment, without manual entry of phone numbers or other contact information on a party-by-party basis.

It may be advantageous to provide a visual external signal regarding the presence of an alarm system or the condition of an alarm state. For example, in one embodiment, a window-mounted camera unit may have a display that is visible from the exterior of the house, or may be capable of emitting auditory signals.

This may be of utility to the homeowners in several ways. First, the state of the system may be visually apparent, whether armed, disarmed or in some other state of monitoring. For example, a system may have red, yellow and green LED's indicating various system states, such as green meaning the system is disarmed, red meaning the system is armed, and yellow indicating there is some issue with the system requiring user attention. Obviously, other lighting indicators or visual patterns may be utilized, including text or auditory displays.

The presence of an external signal may be helpful in assuring the homeowner of the status of the system. For example, if a system were configured to arm automatically as the last registered homeowner's cell phone departs from the residence, a homeowner could visually check in the window on his departure to assure that the system had indeed automatically armed, or could hear an audible tone confirming that the system has been armed. It should be understood that with respect to the visual and auditory signals described here, they could be equally applicable in externally mounted camera configurations, whether at a window or otherwise mounted to a home or in the environs.

The presence of these signals may also be a significant deterrent to would-be thieves. The mere presence of the system in the window may be readily apparent from the street with a red

LED visible in a window, as an example.

Furthermore, a system may be configured in a manner that the light signals when there is a moderate-risk situation underway. As an example, were a car to drive by slowly when the home is vacant and the system is armed, the LED display may shift from red to blinking red, to indicate that all events in the driveway are currently being taped and/or monitored remotely.

Additionally, audible alerts may also be sounded, such as an alarm to alert neighbors and to frighten away thieves.

Additionally, the system may provide audible guidance to a visitor. For example, an unannounced visitor may hear the direction “Please stand in the driveway facing the house, so that you may be identified by the homeowner, who is watching remotely.” Then an image of the person at the home or even live video footage could be passed to the homeowner. This would have the benefit of permitting the system to be disarmed by the homeowner if the visitor were welcome, and the benefit of potentially scaring off a would-be thief.

In one embodiment, the system may be configured to arm certain aspects of an alarm system at night, during prescribed windows of time on specific days of a week. For example, residents may request to be notified of any approach to the home after 9 PM or before 6 AM on every day except Thursday, and to permit an approach (without notification) on Thursday mornings any time after 5 AM (as an illustrative example, to permit the paperboy to drop the weekly local publication at 5:30 AM on Thursdays without notification).

In another embodiment, the machine vision system may be capable of interpreting visual cues that may be provided by a resident or authorized party. For example, in the case of a resident returning home who lost their cell phone, the system may not automatically disarm upon reentry, and may escalate the level of risk due to the arrival of a vehicle and the approach of a person to the residence. The system may or may not signal the individual to identify themselves, either by approaching a camera for facial recognition, for the measurement and assessment of specific body dimensions.

Alternatively, or in combination with other forms of recognition of individuals, gesture-based signals may be provided to the vision system to disarm the system. For example, at system configuration, a user may establish a code for self-identification, which may consist of waving with the right hand, bowing at the waist, and then waving with the left hand. Alternatively, or in combination with these other methods, a path of movement may be utilized to identify an individual, such as walking across the driveway from the front door to a basketball net, walking to the mailbox, and returning to the front door of the house. Alternatively, or additionally, a set of physical characteristics of an individual, such as height, extremity lengths, skin color, or facial features may be utilized as a means of identifying individuals. When the security system observes a specific set of attributes and/or behaviors, the security system may be configured to disarm, as described above.

RFID tags may also be a convenient way of identifying residents, trusted parties or vehicles. The mailbox may be a convenient location for the mounting of RFID reading equipment. As an example, many cars carry RFID tags which are utilized by toll authorities for collecting tolls on various highways. The same RFID tags may be read on entry to the property by an RFID reader located at the mailbox, or another convenient location on the property or in the neighborhood, thereby identifying vehicles entering. In the event that a vehicle enters without a known RFID tag, a different level of risk may be assessed, and if warranted, an alert may be signaled. Separately, additional RFID tags may be provided to a homeowner to allow the vehicles of babysitters, family members and friends to be identified as trusted vehicles. One potential configuration of RFID tags is as key fobs that may be provided to family members or trusted parties; another is as tags that may be affixed to, or even concealed within, vehicles.

Power for the lighting, camera or RFID detection elements may be in the form of wired power supplies, or in the form of rechargeable batteries, which may have means for communicating the dissipation of charge back to the homeowner. Networking of lighting and illumination units exterior to the home may be handled with wires or wirelessly. In the case of wireless systems, wireless repeaters may be useful in spanning longer distances, for example between a home and the end of a long driveway. Battery backup may provide for any electronics installations for the purpose of providing power in the event of an interruption due to either grid issues or intentional severing of power to the residence by would-be thieves.

Actions may be triggered by any set of input parameters, including a history of prior input parameters as an element of the overall set of input parameters (such as prior drive-by behavior of an unidentified car, or prior movements of GPS systems, as just two of many potential examples). These actions may include, but are not limited to doing nothing, storing video footage for a particular period of time, storing metadata for a particular period of time, sending video footage and/or metadata immediately to an external site for storage, providing visual signals exterior or interior to the home, such as by way of illuminating colored LEDs or displaying a text display panel containing a specific or configurable text message, providing auditory signals exterior or interior to the home, such as an alarm signal or auditory requests of personnel within hearing of the home, turning on visible or IR spectrum illumination, providing alerts to the homeowner, providing alerts to neighbors, providing alerts to authorities such as the local police, or arming or disarming other alarm systems or components at the property or neighborhood level.

The nature of alerts may be tiered and hierarchical. For example, if a system were configured to alert a homeowner in the event of a suspected intrusion, a more exhaustive notification scheme may depend upon the response of the homeowner.

In the event that a potential entry by an unidentified person is observed, a primary contact may be notified. If the primary contact is unavailable, the system may follow a protocol of notifying successive contacts until a contact is reached, or failing that, the system may notify the proper public law-enforcement authorities or a private monitoring company. When an individual is reached, they may be provided the option of reviewing video footage, which may allow them to determine whether to disarm the system or to notify authorities of a crime or suspected crime.

The storage of information may also depend upon a user's response to an image or images of a potential event at the property. For example, in the case of a person pulling into the driveway, an alert may be sent the homeowner, along with video or still imagery, which may then inform the homeowners' decision about how to treat the event.

Showing video footage shall be understood herein to encompass the possibility of showing still photographs excerpted from video footage, or of simple still photographs taken of observed activities.

One of the events that may be accounted for is the loss of power at a home. A homeowner may be automatically notified if power is lost, and that may also trigger sending recently recorded video footage (which may have been routed to a central server prior to the power loss). Since the logic for these actions cannot be calculated at the residence in the absence of power, the central server may have specific logic for this event, as well as for the storage of video and metadata from other events.

The data received from one home may be beneficially leveraged in combination with data from other sources. For example, in a neighborhood with multiple installations, the approach of an unidentified car to more than one home without entry may be considered suspicious. Specific patterns of timing associated with entry into a neighborhood and the approach to a home may also be considered suspicious, such as a car not moving directly from the entry to a neighborhood to its destination.

Additionally, in a network having a central data repository spanning more than one neighborhood, the data gathered from one neighborhood may be of assistance in evaluating threats in another neighborhood. For example, a vehicle entering one neighborhood and driving slowly through the neighborhood without making any stops may be considered even more suspicious if that same pattern is observed again in other neighborhoods.

Other source(s) of data outside the neighborhood may also be utilized beneficially to enhance the security of both an individual residence and neighbors. For example, a public authority may provide a listing of stolen vehicles, and the entry into the neighborhood or a particular resident's driveway of a vehicle bearing a plate identified as belonging on a stolen vehicle may trigger alerts that could include a resident, neighbors, and/or the police. A vehicle registration database may be provided that permits the license plate of a vehicle to be compared with the make and model observed, to confirm that the plate shown is registered to the vehicle bearing it, and that the plate has not been switched across vehicles.

The security system may also be capable of learning patterns of traffic and whether or not an alarm condition should be associated with particular circumstances. For example, if a resident were to hire a new babysitter, who might arrive in the driveway at the residence prior to the return of the residents on her first day, that might prompt the system to issue an alert or a warning to the residents. However, if the resident indicates through a user-interface that this vehicle belongs to a welcome guest, who is normally expected to arrive on weekdays between 2 PM-5 PM, then the security system can in future instances of this car's arrival reduce the risk level associated with the vehicle during those windows.

These patterns of traffic may be advantageously studied at the neighborhood level, as well as at the level of a residence. For example, if a vehicle is observed to have entered a neighborhood every week over the period of a year, and if there have been no reports of any alarms or incidents, the risk level associated with that vehicle's entry may be reduced, even without specific user input about that vehicle. Conversely, if a vehicle has been identified as previously being in the area of a crime (even if the vehicle was not positively identified by authorities), the level of risk associated with the vehicle may be elevated.

These methods may be of further use when employed in an embodiment such as a network of roadside cameras located at entry and exit points of a plurality of neighborhoods, employing license plate identification, and coupled together over a communications network. For clarity, license plate recognition as described in this document should be understood as comprising fairly sophisticated image processing that locates the plate on the car and applies specific filters and heuristics, straightforward optical character recognition, which can be performed by a variety of providers of off-the-shelf software, or other methods of license plate recognition.

In such an embodiment, it may be possible to create both a security and deterrent system that is shared by a neighborhood or community, while providing a higher-performing and more cost-effective solution than traditional independent security systems. In such an embodiment, the cost of installation and monitoring of the camera network may shared by a large number of parties within the neighborhood, reducing the cost for each individual location.

The cameras may be advantageously located at the entrance and exit to the neighborhood, with signage that communicates to would-be thieves that the neighborhood is under constant surveillance, acting as a deterrent. As part of this signage, an announcement that solicitors visiting the neighborhood must register in advance may act as a deterrent to would-be thieves going door-to-door posing as solicitors. The system may keep a list of registered parties in the neighborhood, or separate lists of residents, solicitors, suspicious vehicles, and so on.

This signage may be interactive. For example, the signage may contain a display screen that shows a tailored message or requests an individual to identify themselves. Identification may be by various means, which may include any combination of: license plate recognition;

identification of RFID tags on a vehicle; images of a passenger; having a passenger text or verbally communicate information to a monitor such as a name, a residence to be visited, etc; a mobile application that provides identifying data through RF, wireless or cellular communications, or other means. The interactive display may prompt a visitor to proceed once identified, and may additionally provide notice to the residence where the visitor is due to arrive.

As mentioned above, one convenient mounting point for such a monitoring system may be a mailbox located near to the entry or exit of a neighborhood. The monitoring system may be located at other locations. Wherever cameras may be located, if multiple cameras may be employed, or a single camera with two views, in order to provide views of both the front and back of cars as they enter and leave the neighborhood, that may provide additional benefits in vehicle tracking, speed assessment and the machine vision analysis of identifying features.

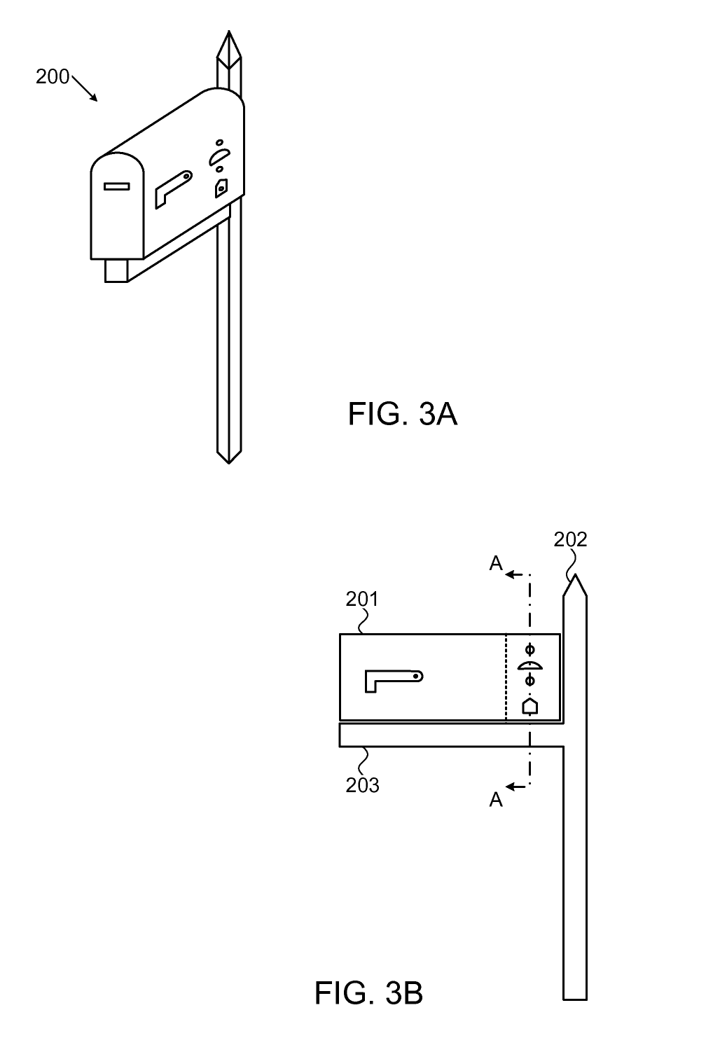

FIG. 3A shows a mailbox camera in accordance with an embodiment of the present invention. FIG. 3B is a side view of the mailbox camera shown in FIG. 3A. FIG. 3C is a cross sectional view of the mailbox camera shown in FIG. 3A. A mailbox 200 is supported by a post 202 via a cross-beam 203. The mailbox may meet standards of the local or federal postal codes, such as opening size, orientation of flag, and so on. A divider wall (shown as a dashed line in the side view) may separate key functional components from normal mail deliveries.

Section A-A shows details of one potential configuration of functional components. An outer shell of the mailbox 210 is removable through the use of a key in two locking mechanisms 211 on either side of the mailbox, and allows the outer shell 210 to be removed. Inside the shell, a connector assembly 214 allows electronics in the functional unit above to feed wiring connections through the beam and post assembly in order that wiring for power and networking may be run back to the home. This wiring is not shown in the illustration, but is understood to run from the internal components to this connector, and then from the connector down the post, and finally from the post back to the home. Both power and networking may be provided in this manner, or networking may also be provided via radiofrequency (RF) communications, such as WiFi protocols such as 802.11(g) or similar means.

In this embodiment, two cameras 215 may be located on opposite sides of the mailbox, with lenses 216 which permit an exterior view, though it should be understood that configurations with one camera or more than two cameras may at times be appropriate. The lenses 216 may be protected from rain and the elements by a rain shield 217, which may be formed by an outward protrusion in the mailbox outer shell 210 above the aperture that the lens sights through. Illumination of an area may additionally be provided through lighting elements 218 on one or both sides of the mailbox.

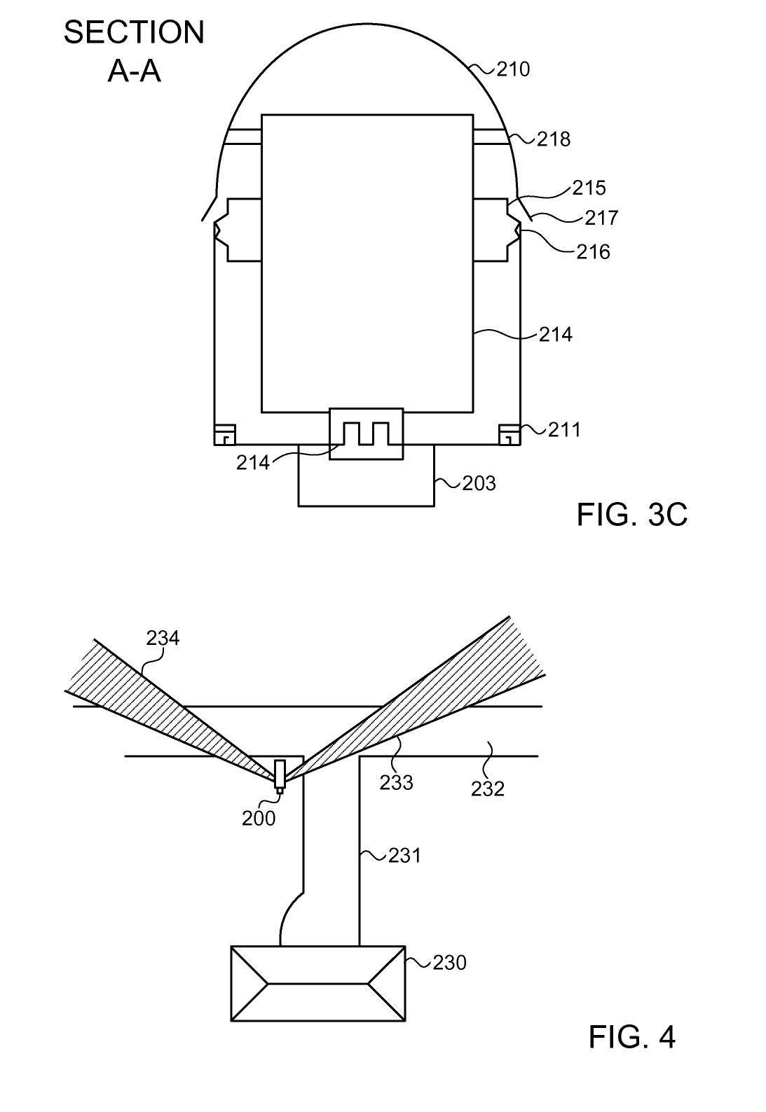

FIG. 4 shows the field of view of the camera shown in FIG. 3A. A mailbox camera assembly 200 is located at the end of a driveway 231 of a residence 230. The mailbox camera assembly may have views in either direction of the street, with the field of view on the left shown as 234 and on the right as 233. In this case, both fields of view provide a clear view of the street 232, and the right hand field of view 233 also provides a clear view of the driveway, so that any vehicle entering the driveway may be captured on video.

The field of view of the cameras may be advantageously oriented in a forward direction, as shown in FIG. 4, as streets will normally be located forward of mailboxes. Adjustment of the field of view may be made within the camera assembly, according to preset configuration angles, which have been pre-calibrated so that the system may accurately calculate distances and speeds.

The advantages of this type of arrangement are easy installation, blending in with the environment of a neighborhood without making security camera views too obvious, and being located in a spot that provides concurrent clear views of a driveway entry and the street in two directions. Estimates of speed, automotive size, features and identifying information are also facilitated by the proximity to the road, and the fact that a front view and a back view may be available for any vehicle passing.

Multiple neighborhoods may share data over a secure network in a manner that allows suspicious vehicles or patterns of suspicious traffic to be identified. The data used in the identification of suspicious parties may come from the monitoring cameras, from residents, from law enforcement authorities, or from other sources. In the event of an incidence of theft, the stored data and video may be helpful to law enforcement authorities in identifying the criminals involved, and in recovering stolen property.

In an embodiment of this invention, a neighborhood has a number of entrances and exits, which may be one road, two roads, or any number of roads. For the purpose of this disclosure, entrances and exits to a neighborhood may be referred to as “access points”, and cameras may be located at an access point so that a vehicle entering or exiting the neighborhood may be monitored. Additionally, other means of identifying a vehicle entering an access point may be utilized, which may include measures such as RFID tags on a vehicle, the entry of a key-code at a numeric or alphanumeric keypad, voice identification, facial recognition, among other potential measures.

It should be understood in the context of this application that a “neighborhood” may comprise several homes, or it may be significantly smaller or larger. At the smallest scale, the same methods applicable to tracking traffic in a neighborhood could be applied to an individual home, and the driveway may comprise the set of entrances and exits for vehicles. Although the benefits of costs savings achievable within a neighborhood of 100 homes may not be realizable at the scale of a single home, certain aspects of this invention may still be helpful, useful and warranted at this smallest scale “neighborhood”.

At a larger scale, it should be understood that a “neighborhood” may be as large as 30 thousand homes, or a municipality, such as a town or city. In this case, the “access points” to the town or city may be a set of roads comprising the predominant means of entering and/or leaving the town or city.

The camera network may separately surround two or more independent neighborhoods. Alternatively, the camera network may surround two adjoining neighborhoods, which share a common border. In the case of a shared border, vehicles exiting one neighborhood may concurrently be entering the adjoining neighborhood. So the gate to one neighborhood may concurrently act as an access point to the second neighborhood as well.

While the above descriptions of various embodiments of this invention describe a process of first identifying a vehicle at a station located near an access point, and then subsequently tracking its movements inside a specific area, it should be understood that observation sequences may be reversed. Specifically, a vehicle may enter an area during a time when a station may be inoperable, due to weather, equipment failure, or for other reasons. In such a case, the vehicle's location may still be tracked within the controlled area, and the vehicle may be positively identified as it leaves the area. Even in a reversed sequence of observation, significant observations can be made about potential risks, and appropriate actions can be taken before or after positive identification of the vehicle.

The cameras may have communication capability to an electronics network, such as a wired or wireless signal to a nearby home, a direct connection to the internet, or a connection to a home and through the home to the internet. Data may be passed back to the internet periodically on a communications network, and such data may include such information as the license plate of vehicles, the make and model of the vehicle, the direction of travel, or the speed of travel. The cameras may have local storage of high definition video footage for a specified period, which could be for any length of time, such as any number of hours, weeks or years, and means to convey video or meta data associated with video to a storage device at a nearby property or at a remote database.

For clarity, although a processor has been discussed as a single processor, it should be understood that any number of processors may be used. In particular, a processor located at an imaging device may perform certain functions, while a processor located at a central processing station may perform other functions. By moving analysis to the edge of the network, transmission of video data may be reduced, reducing overall system and communication costs.

The cameras may communicate via this network with a central data repository, which may gather data from a plurality of cameras at the access points to a plurality of neighborhoods. The central data repository may also receive a plurality of data signals from other sources, which may include consumers, businesses, vehicle owners, law enforcement operations, and other system for tracking vehicles and/or persons.

For example, a consumer may identify a vehicle as belonging to them, and provide an address of their residence, where the vehicle may be regularly garaged. Businesses may provide information on the license plates of regular employees. Law enforcement officials or vehicle owners may provide information on lost or stolen vehicles. Government agencies may provide lists of registered license plates, which may contain information on the status and/or expiration of registrations, and the types of vehicles to which the registrations apply. Law enforcement agencies, individuals or other sources may provide information to the central repository on the location and timing of crimes, such as vehicle or property theft.

A set of data analysis heuristics may be present in a data-analysis module on a computerized system in communication with the central data repository. A set of data analysis heuristics may be present at the local level, and a separate data repository and/or set of heuristics may also exist remotely.

Either a local or remote data analysis module or modules may accumulate a history of patterns of entry and exit from the neighborhood over time. For example, a resident of the neighborhood who regularly leaves the neighborhood on weekday mornings and regularly returns in the evenings might be classified as a “resident”. Another resident, who may not work, and who may not have a regular pattern of ingress and egress, but still has a pattern of regular overnight stays in the neighborhood may also be identified as a “resident.” Finally, a resident may have identified themselves as a “resident” through an online interface or subscription, and may have identified one or more vehicles belonging to them.

The data analysis system may also create additional classifications of vehicles, which might include categories, such as “regular visitors”, for people regularly visiting the neighborhood such as babysitters, friends or household employees, “law enforcement” for law enforcement vehicles, carriers of mail and other deliveries, and “unknown” for vehicles who have not yet had an identifiable pattern of visits to the neighborhood.

In many cases of theft, there are patterns of traffic that precede and follow an incidence of theft, which may include a week of “casing” a neighborhood, followed by an event, and then no further traffic. After being notified of an incidence of vehicle or property theft, the traffic patterns leading up to the crime may be analyzed to attempt to identify suspicious patterns of behavior. In this process, regular traffic such as residents and regular visitors may be filtered out, and specific patterns of ingress and egress may lead to the identification of specific vehicles as “suspicious”.

Other signals may be utilized to identify suspicious vehicles or periods of suspicious activity. In one embodiment, an alarm system located at a home, business or on a vehicle in the neighborhood could send a message to the neighborhood level security system. Alternatively, a resident might contact a central call center or send an alert via a computer or mobile device indicating that they had observed a suspicious person in the neighborhood. As yet another example, a resident may inform the security company or the police of a robbery that has occurred. In response to such a notice, the central repository may then mark all traffic into our out of the neighborhood as suspicious for a given window of time before or after such a report. Video records, and/or metadata may be obtained from local storage sites, retained over an extended period, and/or may be provided to authorities, such as by forwarding video footage of a suspicious party to the local police, along with license plate information.

In another embodiment, LoJack® vehicle tracking or other vehicle tracking systems may have identified a vehicle as stolen, and may have identified the vehicle's location at a point in time. The vehicle's plate may have been removed, changed or disguised, and the new plate may be observed as the vehicle exits the neighborhood, even if the old plate has been removed, and the tracking device disabled. This type of data may be helpful to law enforcement agencies in catching criminals and recovering stolen property.

Another example of a suspicious data pattern in a neighborhood security network may arise from combining cell phone GPS data with data gathered from local monitoring. A law enforcement agency may designate a particular cell phone as suspicious, and data from that cell phone's location may be tied to the location of a vehicle, which may subsequently be marked as “suspicious”. Certain felonies, such as sexual attacks may require parolees to bear GPS tracking devices, and the presence of these felons, and whether they enter a neighborhood may be tracked.

Alternatively, a resident's cell phone may normally travel in his vehicle with him when he leaves the neighborhood. In the case where the vehicle leaves the neighborhood without that resident's phone present, the departure of the vehicle may be flagged as “suspicious.” A system may be configured to immediately notify a resident if his vehicle is in motion without his cell phone present and moving along with the vehicle's movements. Similar patterns may also be considered with regard to a resident's keys, which may be equipped with an RFID tag as a key fob, as yet another example.

What is learned from patterns in one neighborhood may be applied to the data analysis heuristics in other neighborhoods. For example, in a town with a pattern of break-ins, a vehicle identified as “suspicious” in one neighborhood may start to follow a similar pattern of multiple visits “casing” a second neighborhood. The second neighborhood may then be provided an alert, and/or the methods of monitoring and storing video data in the second neighborhood may be suitably adjusted.

One or more property cameras may pass data to property-level machine vision analysis systems, generating property-level metadata. Such metadata may be stored locally, and may also be passed to a central database for storage in a central database, along with selected excerpts of video footage. The video footage passed to the central system may be a function of specific metadata tags and levels of risk assessment.

The metadata may be used at the local level in conducting local risk assessments, which may rely on information provided at the property level, at the neighborhood level, from a central database, which may have received other sources of non-property based, or non-neighborhood based information, or from any of the data storage sites in the system, including storage at the camera, property, neighborhood or central level. (Note that storage at the camera level is intended to be encompassed within “property level” storage).

As mentioned above, the central database may also receive information from other sources, which may include GPS data from cell phones, vehicles, tablet computers and other computing devices, GPS navigation devices and the like. The central database may receive additional data feeds from other neighborhoods, from safety authorities, from vehicle registries, from facial recognition databases, and/or from other sources.

In response to the various inputs at the property, neighborhood and central level, the system may make certain judgments about the risks associated with a particular situation, and may adjust the storage time of video data at the property, neighborhood or central level, or may cause or cease to cause a video stream to be transmitted across levels. Several examples of how risk levels may be impacted by specific observations at the property or neighborhood level were presented in the examples above, and further discussion of the means of identifying risks will follow.

It is to be understood that any number of properties may contribute in providing data to a central database, and information from one property may impact risk assessments at another property. Similarly, any number of neighborhoods may be fed into a single central database, and data from one property or neighborhood may be considered in assessing the level of risks at another property or neighborhood.

The data passed to the central database or a local analysis module may be checked in a variety of manners. For example, the make and model of the vehicle may be compared to data from the vehicle registry, to verify that the plate belongs on that vehicle. The speed may be checked against local speed ordinances. The license plate may be checked against a list of lost or stolen vehicles, or to see if the license plate has been identified as “suspicious” by the authorities, by residents, by some other source, or through analysis of data patterns, as described above. There may be more than one way in which specific license plates are marked as “suspicious”, which may include any of the above parameters, other parameters, or combinations of two or more parameters.

In addition, data may also be checked at the location of the monitoring camera. For example a local monitoring camera may have its own computer, local database and local analysis module, which may allow it to immediately classify a vehicle as “suspicious”. Aside from monitoring and analysis efforts aimed at reducing the risk of property theft, there are other means of ensuring neighborhood safety, which may include, among other goals, controlling vehicle speeds in the neighborhood, alerting neighbors to the presence of unknown persons, controlling sales calls and/or political visits in a neighborhood, and so on. Appropriate alerts for any of these situations may be propagated through a neighborhood, or to particular residents requesting such notification, such as alerting homeowners if they themselves are observed to be moving in excess of posted speed limits, or alerting particular parties if residents (or visitors) are observed to be repeatedly speeding.

Decisions about data storage may be made at the central data repository or at the local level, and data may be archived at the local level and/or in the central repository. The ability for the system to categorize vehicles may be extremely helpful in limiting the volume of video information stored by the system. For example, complete video footage of unknown or suspicious vehicles may be retained for weeks, whereas video footage of residents' cars entering the neighborhood may not be retained for as long a period.

The risk assessment process may be conducted by a number of means. For example, various video feeds may have been fed into machine vision modules which are capable of identifying events and assigning metadata to events such as is shown in the list below.

Potential examples of metadata associated derived from video feeds may include: a vehicle passed monitoring station A heading east at 12:07 PM; the vehicle's license plate is XYZ 123; the vehicle appears to be a white Dodge Dakota; the vehicle appears to have one driver and one passenger; the passengers heads were oriented in a forward facing position; the vehicle was traveling at 25 mph.

The same vehicle passed monitoring station A heading west at 12:27 PM; the vehicle's license plate is XYZ 123; the vehicle appears to be a white Dodge Dakota; the vehicle appears to have one driver and no passengers; the passengers heads were oriented in a forward facing position; the vehicle was traveling at 22 mph; the duration of the stay in the neighborhood was 20 minutes.

This data may be combined with other data from other sources, such as property monitoring equipment at a home, GPS data feeds and other data sources, which may include data from public safety authorities, public license registration databases, private listings of license plate and other information provided by residents, and other sources of information.

Continuing the above example, in this instance, these feeds might provide this additional information:

From Registry Databases: e.g., the vehicle license plate XYZ 123 is registered to David Smith; the vehicle license plate XYZ 123 is for a white Dodge Dakota.

From David Smith's home security system: a video feed showed a white Dodge Dakota with license XYZ 123 approaching the home at 12:15 PM; a video feed showed a passenger leaving the car and entering the home at 12:16 PM; an entry to the home was noted by a door proximity switch at 12:16 PM; the appropriate security code was entered on a home security system at 12:17 PM.

From information provided by residents: David Smith's cell phone is (123) 456-7890.

From information provided by a cell phone carrier (with David Smith's permission): the GPS on cell phone (123) 456-7890 shows that it was traveling east past monitoring station A at 12:07 PM; the same GPS was traveling west past monitoring station A at 12:27 PM.

From information provided by public safety authorities: the vehicle XYZ 123 is not on any list of stolen or suspected vehicles; the speed limit at station A is 25 miles per hour.

Rules about expected patterns provided by residents: David Smith has requested to be notified if his car is observed moving through a location without his cell phone present

After the data is interpreted, a risk assessment procedure is conducted in several parts. First, certain conditions may be checked according to pre-established expected patterns.

For example, for the data above, the expected patterns may include:

David Smith's cell phone should travel into and out of the neighborhood with his car. When observed to be consistent with expected pattern, the situation is evaluated as normal.

The type of vehicle observed should match the type of vehicle associated with a license plate registration. When observed to be consistent with expected pattern, the situation is evaluated as normal.

The license plate should not be on a list of stolen or suspicious vehicles. When consistent with expected pattern, the situation is evaluated as normal.

There should not be any alarms from a residential alarm system. When consistent with expected pattern, the situation is evaluated as normal.

The vehicle is moving within 5 mph of posted limits. When consistent with expected pattern, the situation is evaluated as normal.

Obviously, in the case above, we selected an instance where the situation observed was of a neighborhood resident and followed an expected pattern. A similar structure could be followed in identifying exceptions associated with an unrecognized vehicle, even if it passed as “normal” relative to registry databases and speed limits.

Examples of other types of exception tracking are given below.

It is expected that the type of vehicle observed should match the type of vehicle associated with a license plate registration. If observed to be consistent with the expected pattern, then the situation may be evaluated as normal.

The license plate should not be on a list of stolen or suspicious vehicles. If consistent with the expected pattern, the system may evaluate the situation as normal.

There should not be any alarms from residential alarm systems. If consistent with the expected pattern the situation may be assessed as normal.

The vehicle is moving within 10 MPH of posted limits. If observations are consistent with the expected pattern, the situation may be assessed as normal.

Non-resident's cars should proceed directly to and from a single destination. If a car were observed passing multiple locations not in a direct path then this could be noted as an exception.

Non-residents cars should move through the neighborhood within 10 MPH of stated speed limits. If a car were observed going by driveways at a slow rate of speed this could be noted as an exception.

Non-residents soliciting from neighborhood homes should be pre-registered. If a car is observed stopping at multiple residences this could be noted as an exception.

An exception is not necessarily an imminent threat, and communities may establish their own guidelines for the treatment of exceptions, which can readily be integrated into logical algorithms. An example of the treatment of exceptions by one neighborhood may be: If an unknown vehicle enters neighborhood, then store data for at least 7 days.

The type of vehicle observed should match the type of vehicle associated with a license plate registration. If not, authorities are notified immediately, video is sent, the neighborhood point person for the security system is notified, and data is stored for at least 60 days.

The license plate should not be on a list of stolen or suspicious vehicles. If not, authorities are notified immediately, video is sent, the neighborhood point person for the security system is notified, and data is stored for at least 60 days.

There should not be any alarms from any residential alarm systems. If there are alarms, authorities are notified immediately, video is sent, the neighborhood point person for the security system is notified, and data is stored for at least 60 days.

The vehicle should be moving within 10 MPH of posted limits. For residents' registered vehicles notify the neighborhood point person if the speed is 10 MPH above posted speed limits more than twice in a given period. For non-residents: notify neighborhood point person if the speed is 10 MPH above posted speed limits and notify authorities if speed is 15 MPH above posted limits; store data at least 60 days.

Non-resident's cars should proceed directly to and from a single destination. If not, then notify neighborhood point person; notify homeowners who own homes where stops were observed; notify other homeowners who have requested such notification; store data for at least 60 days.

Non-residents soliciting from neighborhood homes should be pre-registered. If not, notify neighborhood point person, who may ask that authorities be notified, and store data for at least 60 days.

Resident's cell phone should travel into and out of the neighborhood with his car. If not, then notify resident via cell phone, home phone and alternate phone (or as requested) and store data for at least 60 days.

Theft or alarm reported by a resident or property owner. If an alarm is reported, notify residents requesting such notification, store data for the week preceding theft for at least 60 days, or until released by the authorities.

Exceptions may also be characterized as to whether they represent an immediate threat to the neighborhood or its residents, or a more subdued level of suspicious activity. For example, the movement of a stolen car into the neighborhood could pose an immediate threat, and prompt immediate notification of both residents and the authorities. In contrast, a solicitor may be an exception to the expected levels of traffic in the neighborhood, and be assessed as a moderate risk, without prompting an immediate call to the authorities. Nonetheless, in the case of either moderate risk events or events that represent an immediate threat, various schemes of notification may be appropriate.

As shown in some instances above, the data analysis and risk assessment module may have specific triggers for certain notifications. For example, in the case of a suspicious car entering the neighborhood, any of the following may be notified: local law enforcement, residents or a subset of residents of the neighborhood, a monitoring company, and/or other agencies or parties. In the case of a vehicle speeding, the system may notify a resident directly that they were observed speeding, a neighborhood point person, a monitoring company, or the local authorities may be notified. Notification may be via local display, e-mail, phone, fax, text, by the postal service or via other means. This reporting may be conducted with regard to specific protocols or filters, such that residents observed speeding may be notified directly; whereas the authorities may be notified automatically in the case of non-residents speeding through a neighborhood.

Other methods of notification may be helpful in making residents feel secure and deterring crime. The camera monitoring systems may include visual displays. For residents returning at night, the displays might be tailored to say “Welcome back, John”. As an unidentified car is entering a neighborhood, a sign might flash “Welcome to our neighborhood, secured by XYZ,” signaling that any vehicle entering or exiting is being tracked. Vehicle speeds could be displayed for passing vehicles for informational purposes or as a deterrent to limit the frequency of speeding in a neighborhood.

More complex structures of notification are also possible, such as notifying the president of a community association if a resident is speeding on multiple occasions, or if vehicles are observed to be traveling in suspicious patterns of traffic. Insurance providers may be notified if specific patterns of travel are observed, such as regular speeding or the use of vehicles registered to minors at inappropriate times under graduated driving laws. When a vehicle owner who has provided access to his cell phone GPS signal is observed to be in a different location than his vehicle, a notice may be sent to him on his phone—“Did you know your car is headed south on I-89 at this time?”

These examples are intended to be illustrative, and it should be understood that the set of potential means of identifying suspicious traffic patterns, and the potential thresholds for notification are prohibitively exhaustive to list individually.

In a given neighborhood, the data analysis module may infer from the ingress and egress of vehicles into the neighborhood an inventory of vehicles in the neighborhood at a point in time. A network of adjacent neighborhoods, each surrounded by access points, could permit one to infer the travel of a vehicle from one neighborhood to the next. An independent network for tracking vehicles, such as data from an automated RFID tollbooth system, may be integrated to provide additional information on vehicle travels and/or whereabouts.

Vehicle location data could be provided to various parties for various purposes. For example, if a car were stolen, the car's make, model and license plate could be fed into the system. The system might then be able to immediately identify a neighborhood in which the vehicle was currently located. Alternatively, a parent looking for a child driving a vehicle might be able to query the system as to the whereabouts of their child. Insurance companies facing a claim on a stolen car may be able to trace back the location of the car over time to confirm information provided by a policyholder or to identify cases of insurance fraud.

While mailbox-mounted systems may provide an excellent view of streets at the entrance and exit to a neighborhood, the powering and data transmission to a mailbox from a residence is slightly complicated. Professional installation may be required to run wiring for power and/or data transmission, in order to avoid having to deal with frequently replacing batteries or managing wireless transmission. Although a mailbox-mounted system may be more expensive for this reason and require professional installation, if the data is useful to a broad set of homeowners throughout a neighborhood, its cost may be warranted and shared among participating households in the neighborhood.

But there may be cases where individual homes wish to have their own security measures present, and wish to do so with a minimum of installation costs. In one embodiment, to minimize installation costs, and in order to facilitate mounting of a camera by a consumer with a clear view of the entrance path or driveway, a camera may be mounted to a window. A camera may be rigidly mounted to a window frame, it may adhere to a window utilizing suction or adhesives, or it may be otherwise mounted to the window. If a camera is mounted to the window, shielding materials may be used around the camera, to prevent the entry of light around the camera into the area between the camera and window, and to minimize the reflectance of interior light back to the camera at night. In the case of such an installation, illumination may be provided by a separate or coupled lighting module also adhering to the window in a similar manner, with a shield to prevent the means of illumination from reflecting off the glass back to the camera.

The benefits of this type of an installation are that the camera is shielded from the exterior elements, the camera is not negatively impacted by interior illumination, the camera can connect to a local area network either wirelessly or via wires with a minimum of installation costs, and the device can easily be powered from an interior power outlet.

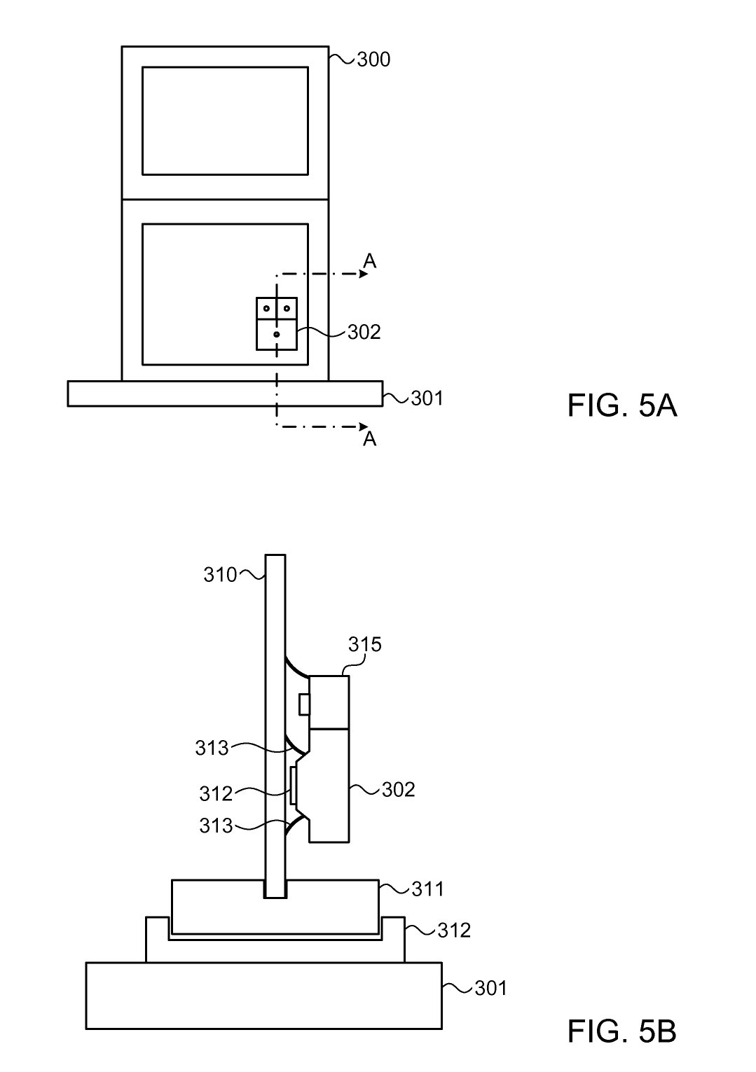

FIG. 5A shows a window camera installation. FIG. 5B shows a cross section of the installation shown in FIG. 5A. A window 300, which provides a view of a driveway or pedestrian access path to the home, is shown. A camera assembly 302 is mounted to the window, on the interior of the home, providing an exterior view.

Section A-A shows one method by which a camera may be mounted to a window. This section view shows a window pane 310, which sits in a window frame 311, that is seated in molding 312 on top of the window sill 301. The camera 302 contains a lens 312, which is oriented to have a view through the window out onto the driveway or entrance path. This camera assembly may have means to adjust the angle of view (not shown) on either a permanent fixed basis, or with the capability to pan and zoom.

Opaque flaps 313 may be present around the periphery of the camera area, and shield the camera lens from interior illumination, which might otherwise pass around the edges of the camera, be reflected off of the window pane glass and hit the camera lens. These flaps may also be utilized to provide suction, helping to hold the camera against the window. The camera may be held in place solely by this suction, or other means to provide support to the camera from the frame or sill may be provided (not shown).

One alternative means of support (not shown) is to utilize magnetic forces through the glass to affix a camera assembly, as an example: with magnets located on the outside of the glass, and the camera assembly in a magnetic steel frame which is then coupled to the magnets through the window. But it should be understood that the frame itself could contain magnets, with the exterior components being magnetic materials, or magnets could be place on either side of the window to provide such attraction.

As part of the camera body, there may be means to capture an image, store an image, and transmit an image over a wireless or wired network to a computer. The computer may conduct machine vision processing of the image to assign appropriate metadata tags to specific events, or such analysis may be conducted on a processor located with the camera itself, passing both video and meta data over the network. Power supply to the camera is not shown, but a cord running to a local power supply is a simple solution that is readily understood by one skilled in the art.

A separate lighting module 315 may sit above the camera, and illuminate the field of view with visible light or light in the IR spectrum in order to provide enhanced visibility in the monitored area. The light may be located on the outside of the shielding surrounding the camera, in order to avoid having the window glass reflect light back to the video monitoring camera.

The separate lighting module 315 may also contain visual indicators for a person on the exterior of the home. For example, in the front view of the window at the left, two lights are shown. One could be utilized for illumination purposes, and the other could be an LED array, which signals red if the system is armed, green if the system is disarmed and yellow or blinking for selected other conditions.

The lighting module may also contain a directional laser at a known orientation, which may be useful in assessing the distance to certain objects. Such a laser may be inside or outside of the visible spectrum, but may be observable by the camera electronics. Such a module may also be applicable in other camera installations, such as a mailbox assembly, in positively identifying a line of sight, which may be useful in stitching together imagery from multiple video snapshots and/or multiple cameras.

It should be understood that this particular mechanical configuration of a camera is just one of many practicable embodiments of this invention. The camera and lighting configurations may be modified in terms of how they are supported and shielded, so long as a clear exterior view is provided. In fact, exterior mounted camera assemblies may be preferred in some installations, but this window-mounted configuration may permit for the simplest installation by a homeowner.

Aside from providing security at the property level, the data from such an installation may also have utility at the neighborhood level. As just one example, a neighborhood access point camera may note the arrival of a car in the neighborhood, and a property-based camera may subsequently be utilized to identify the arrival of the same vehicle at the residence. As has been previously described, the presence of both the neighborhood and residential data may be advantageously considered in combination in evaluating overall levels of risk at both the property and neighborhood level.

Embodiments of the present invention may be embodied in the form of a system, a method or a computer program product. Similarly, examples may be embodied as hardware, software or a combination of both. Embodiments of the present invention may be embodied as a computer program product saved on one or more non-transitory computer readable medium (or media) in the form of computer readable program code embodied thereon. Such non-transitory computer readable medium may include instructions that when executed cause a processor to execute method steps in accordance with some embodiments. In some embodiments the instructions stores on the computer readable medium may be in the form of an installed application and in the form of an installation package.

Such instructions may be, for example, loaded by one or more processors and get executed.

For example, the computer readable medium may be a non-transitory computer readable storage medium. A non-transitory computer readable storage medium may be, for example, an electronic, optical, magnetic, electromagnetic, infrared, or semiconductor system, apparatus, or device, or any combination thereof.

Computer program code may be written in any suitable programming language. The program code may execute on a single computer system, or on a plurality of computer systems.

Embodiments of the present invention are described hereinabove with reference to flowcharts and/or block diagrams depicting methods, systems and computer program products according to various embodiments.

Features of various embodiments discussed herein may be used with other embodiments discussed herein. The foregoing description of the embodiments has been presented for the purposes of illustration and description. It is not intended to be exhaustive or limiting to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes that fall within the true spirit of the disclosure.

1. A system comprising:
a station to identify a vehicle and to determine a characterizing feature of the vehicle;
an imager located remotely from the station, the imager to acquire an image of the vehicle that includes the characterizing feature; and
a processor to detect the characterizing feature in the acquired image and to associate the detected characterizing feature with the identified vehicle so as to predict a location of the vehicle.

2. The system of claim 1, wherein the station is configured to indicate a time at which the vehicle is identified and the imager is configured to indicate a time at which the image was captured.

3. The system of claim 2, wherein the processor is configured to predict a time of arrival of the vehicle at the imager.

4. The system of claim 1, wherein the station comprises a license plate reader to identify the vehicle by reading a license plate of the vehicle.

5. The system of claim 1, wherein the station comprises a radiofrequency identification device for to identify the vehicle by reading an radiofrequency identification tag of the vehicle.

6. A system for predicting an identity of a vehicle detected by multiple sensors, the system comprising:
a first sensor in a first location to detect a unique identifier of said vehicle;
a second sensor in a second location, said second sensor suitable to capture a second identifier of said vehicle, said second sensor not suitable to detect said unique identifier;
a processor, said processor to associate said unique identifier with said second identifier, and to predict that said vehicle detected by said second sensor in said second location is said vehicle detected by said first sensor in said first location.

7. The system of claim 6, wherein said first sensor comprises a license plate reader, and wherein said unique identifier comprises a license plate identifier, and wherein said first sensor is to detect at said first location said license plate identifier.

8. The system of claim 6, wherein said second sensor comprises an imager, said imager in said second location suitable to capture from said second location an image of said vehicle, said image comprising said second identifier of said vehicle.

9. The system of claim 6, wherein one or more instances of the first said sensor encompass the set of entry points of a vehicle to an area.

10. The system of claim 6, comprising a memory, said memory to store a time interval of said vehicle's travel between said first location and said second location, and wherein said processor is to compare said time interval to a prior time interval associated with travel between said first location and said second location.

11. The system as in claim 10, wherein said processor is to compare a velocity of said travel between said first location and said second location with a prior velocity of said vehicle at a point between said first location and said second location.

12. A method for vehicle monitoring, the method comprising:
operating a sensor to automatically identify a vehicle at a first time at a first location;
determining a characterizing feature of the identified vehicle;
operating an imager to acquire an image at a second time at a second location; and
if the acquired image includes the characterizing feature, predicting a location of the vehicle.

13. The method of claim 12, wherein the sensor comprises a license plate reader and identifying the vehicle comprises reading a license plate of the vehicle.

14. The method of claim 12, wherein the sensor comprises an radiofrequency identification reader and identifying the vehicle comprises reading an radiofrequency identification tag of the vehicle.

15. The method of claim 12, wherein determining the characterizing feature comprises acquiring an image of the vehicle concurrently with identifying the vehicle.

16. The method of claim 12, wherein determining the characterizing feature comprises retrieving the characterizing feature from a database.

17. The method of claim 12, wherein the first location comprises an access point to a neighborhood.

18. The method of claim 12, wherein the second location comprises a vicinity of a residence.

19. The method of claim 12, wherein predicting the location comprises determining an expected time of travel from the first location to the second location.

20. The method of claim 12, comprising issuing an alert when the vehicle is predicted to be at a location that is not expected for that vehicle.
